(19) United States
(12) Patent Application Publication
(10) Pub. No.: US 2026/0039855 A1
(43) Pub. Date: Feb. 5, 2026

(54) METHOD, APPARATUS, AND MEDIUM FOR VIDEO PROCESSING

(71) Applicant: Bytedance Inc., Los Angeles, CA (US)

(72) Inventors: Mehdi SALEHIFAR, Los Angeles, CA (US); Yuwen HE, Los Angeles, CA (US); Kai ZHANG, Los Angeles, CA (US); Li ZHANG, Los Angeles, CA (US)

(21) Appl. No.: 19/355,947

(22) Filed: Oct. 10, 2025

Related U.S. Application Data
(63) Continuation of application No. PCT/US2024/024110, filed on Apr. 11, 2024.
(60) Provisional application No. 63/458,571, filed on Apr. 11, 2023.
(60) Provisional application No. 63/584,091, filed on Sep. 20, 2023.

(51) Int. Cl. H04N 19/513; H04N 19/105; H04N 19/159; H04N 19/172; H04N 19/176

(52) U.S. Cl. CPC H04N 19/513; H04N 19/105; H04N 19/159; H04N 19/172; H04N 19/176

(57) ABSTRACT

Embodiments of the present disclosure provide a solution for video processing. A method for video processing is proposed. The method comprises: applying, for a conversion between a current video block of a video and a bitstream of the video, at least one of the following processes on the current video block: a decoder side motion vector refinement (DMVR) process, a first bi-directional optical flow (BDOF) process for refining at least one motion vector (MV) of the current video block, or a second BDOF process for adjusting a sample value in the current video block; and performing the conversion based on the applying, wherein the current video block is bi-predicted based on a first MV and a second MV for the current video block, and a first picture order count (POC) distance associated with the first MV is different from a second POC distance associated with the second MV.

### CROSS REFERENCE

This application is a continuation of International Application No. PCT/US2024/024110, filed on Apr. 11, 2024, which claims the benefit of U.S. Provisional Application No. 63/458,571, filed on Apr. 11, 2023, and U.S. Provisional Application No. 63/584,091, filed on Sep. 20, 2023. The entire contents of these applications are hereby incorporated by reference in their entireties.

### FIELDS

Embodiments of the present disclosure relates generally to video processing techniques, and more particularly, to a bi-directional optical flow (BDOF) process and a decoder side motion vector refinement (DMVR) process.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding quality of video coding techniques is generally expected to be further improved.

### SUMMARY

Embodiments of the present disclosure provide a solution for video processing.

In a first aspect, a method for video processing is proposed. The method comprises: applying, for a conversion between a current video block of a video and a bitstream of the video, at least one of the following processes on the current video block: a decoder side motion vector refinement (DMVR) process, a first bi-directional optical flow (BDOF) process for refining at least one motion vector (MV) of the current video block, or a second BDOF process for adjusting a sample value in the current video block; and performing the conversion based on the applying, wherein the current video block is bi-predicted based on a first MV and a second MV for the current video block, and a first picture order count (POC) distance between a current picture comprising the current video block and a first reference picture referred to by the first MV is different from a second POC distance between the current picture and a second reference picture referred to by the second MV.

Based on the method in accordance with the first aspect of the present disclosure, the DMVR process, the BDOF for MV refinement, and/or the BDOF for sample adjustment are allowed to be used for non-equal POC distance case. Compare with the conventional solution where these processes are only allowed to be used for equal POC distance case, the proposed solution can advantageously extend the application range of these processes. Thereby, the coding quality can be improved.

In a second aspect, an apparatus for video processing is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of a video which is generated by a method performed by an apparatus for video processing. The method comprises: applying at least one of the following processes on a current video block of the video: a decoder side motion vector refinement (DMVR) process, a first bi-directional optical flow (BDOF) process for refining at least one motion vector (MV) of the current video block, or a second BDOF process for adjusting a sample value in the current video block; and generating the bitstream based on the applying, wherein the current video block is bi-predicted based on a first MV and a second MV for the current video block, and a first picture order count (POC) distance between a current picture comprising the current video block and a first reference picture referred to by the first MV is different from a second POC distance between the current picture and a second reference picture referred to by the second MV.

In a fifth aspect, a method for storing a bitstream of a video is proposed. The method comprises: applying at least one of the following processes on a current video block of the video: a decoder side motion vector refinement (DMVR) process, a first bi-directional optical flow (BDOF) process for refining at least one motion vector (MV) of the current video block, or a second BDOF process for adjusting a sample value in the current video block; generating the bitstream based on the applying; and storing the bitstream in a non-transitory computer-readable recording medium, wherein the current video block is bi-predicted based on a first MV and a second MV for the current video block, and a first picture order count (POC) distance between a current picture comprising the current video block and a first reference picture referred to by the first MV is different from a second POC distance between the current picture and a second reference picture referred to by the second MV.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 illustrates extended coding unit (CU) region used in BDOF;

FIG. 5 illustrates decoding side motion vector refinement;

FIG. 6 illustrates diamond regions in the search area;

FIG. 7 illustrates weights generated with an example Gaussian distribution;

FIG. 8 illustrates weights generated with a further example Gaussian distribution;

FIG. 9 illustrates weights generated with a still further example Gaussian distribution;

FIG. 10 illustrates weights generated with a still further example Gaussian distribution;

FIG. 11 illustrates different filter shapes applied on the data;

FIG. 12 illustrates a flowchart of a method for video processing in accordance with embodiments of the present disclosure; and

FIG. 13 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

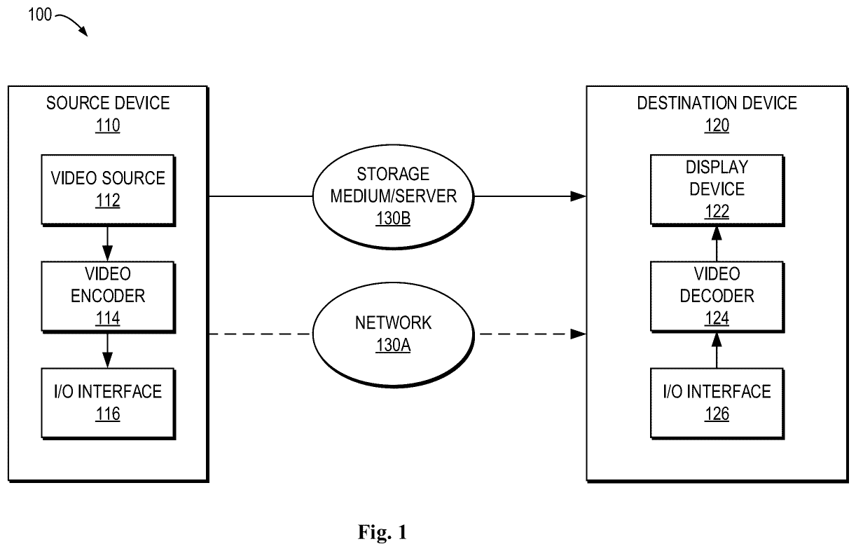

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

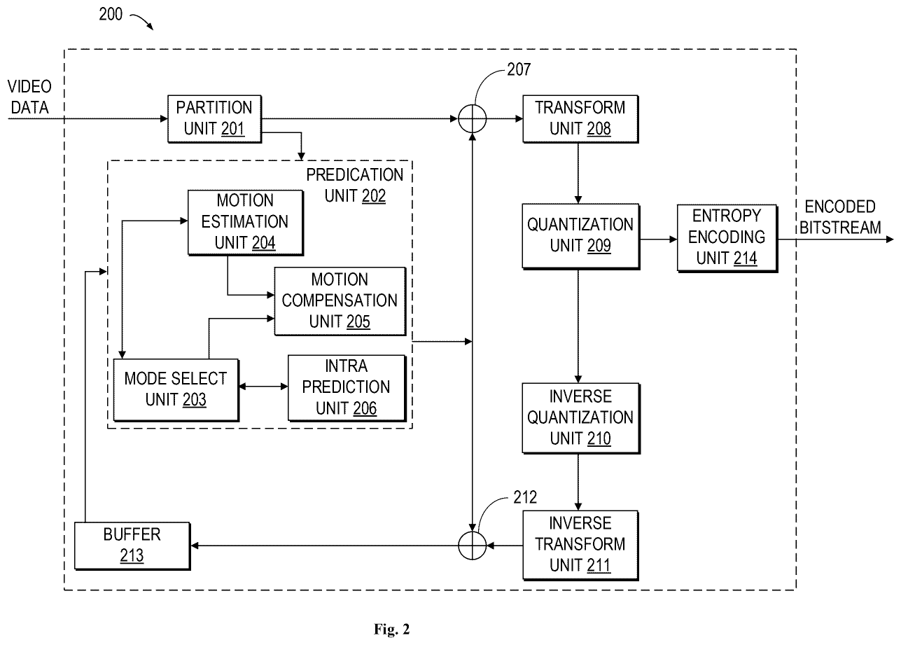

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components.

The techniques described in this disclosure may be shared among the various components of the video encoder 200. In some examples, a processor may be configured to perform any or all of the techniques described in this disclosure.

In some embodiments, the video encoder 200 may include a partition unit 201, a predication unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the predication unit 202 may include an intra block copy (IBC) unit. The IBC unit may perform predication in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter predication (CIIP) mode in which the predication is based on an inter predication signal and an intra predication signal. The mode select unit 203 may also select a resolution for a motion vector (e.g., a sub-pixel or integer pixel precision) for the block in the case of inter-predication.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector predication (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block (s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the predication unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

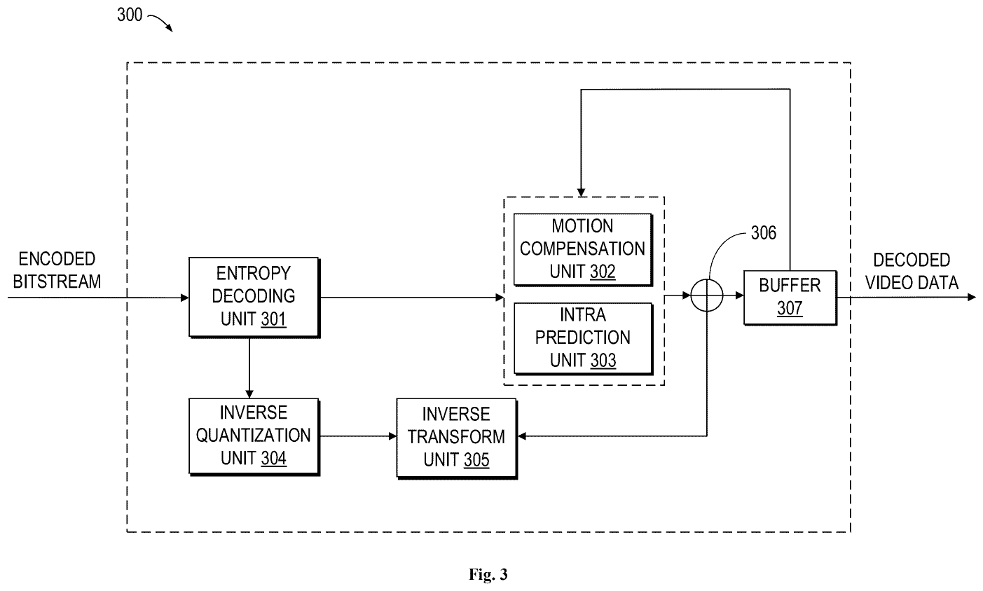

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra predication and also produces decoded video for presentation on a display device.

Some exemplary embodiments of the present disclosure will be described in detailed hereinafter.

It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. Brief Summary

This disclosure is related to video/image coding technologies. Specifically, it is related to bi-directional optical flow. It may be applied to the existing video coding standard like HEVC, VVC, or the next generation video coding standard like beyond VVC exploration such as ECM. It may also be applicable to future video coding standards or video codec.

### 2. Introduction

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC) and H.265/HEVC standards. Since H.262, the video coding standards are based on the hybrid video coding structure wherein temporal prediction plus transform coding are utilized. To explore the future video coding technologies beyond HEVC, Joint Video Exploration Team (JVET) was founded by VCEG and MPEG jointly in 2015. As of July 2020, it has also finalized the Versatile Video Coding (VVC) standard, aiming at yet another 50% bit-rate reduction and providing a range of additional functionalities. After finalizing VVC, activity for beyond VVC has started. A description of the additional tools on top of the VVC tools has been summarized in M. Coban, F. Léannec, K. Naser, and J. Strom “Algorithm description of Enhanced Compression Model 5 (ECM 5),” document JVET-Z2025, 26th WET meeting: by teleconference, 20-29 Apr. 2022., and its reference SW is named as ECM.

### 2.1 Bi-Directional Optical Flow (BDOF) in VVC

The bi-directional optical flow (BDOF) tool is included in VVC. BDOF, previously referred to as BIO, was included in the JEM. Compared to the JEM version, the BDOF in VVC is a simpler version that requires much less computation, especially in terms of number of multiplications and the size of the multiplier.

BDOF is used to refine the bi-prediction signal of a CU at the 4×4 subblock level. BDOF is applied to a CU if it satisfies all the following conditions:
The CU is coded using “true” bi-prediction mode, i.e., one of the two reference pictures is prior to the current picture in display order and the other is after the current picture in display order.
The distances (i.e. POC difference) from two reference pictures to the current picture are same.
Both reference pictures are short-term reference pictures.
The CU is not coded using affine mode or the SbTMVP merge mode.
CU has more than 64 luma samples.
Both CU height and CU width are larger than or equal to 8 luma samples.
BCW weight index indicates equal weight.
WP is not enabled for the current CU.
CIIP mode is not used for the current CU.

BDOF is only applied to the luma component. As its name indicates, the BDOF mode is based on the optical flow concept, which assumes that the motion of an object is smooth. For each 4×4 subblock, a motion refinement (νₓ, ν_{y}) is calculated by minimizing the difference between the L0 and L1 prediction samples. The motion refinement is then used to adjust the bi-predicted sample values in the 4×4 subblock. The following steps are applied in the BDOF process.

First, the horizontal and vertical gradients,

$$\frac{\partial {I}^{( k )}}{\partial x} ( i , j ) and \frac{\partial {I}^{( k )}}{\partial y} ( i , j ) ,$$

k=0,1, of the two prediction signals are computed by directly calculating the difference between two neighboring samples, i.e.,

$$\frac{\partial {I}^{( k )}}{\partial x} ( i , j ) = ( ( {I}^{( k )} ( i + 1 , j ) ≫ shift 1 ) - ( {I}^{( k )} ( i - 1 , j ) ≫ shift 1 ) )$$

$$\frac{\partial {I}^{( k )}}{\partial y} ( i , j ) = ( ( {I}^{( k )} ( i , j + 1 ) ≫ shift 1 ) - ( {I}^{( k )} ( i , j - 1 ) ≫ shift 1 ) )$$

where I^{(k)}(i, j) are the sample value at coordinate (i, j) of the prediction signal in list k, k=0,1, and shift1 is calculated based on the luma bit depth, bitDepth, as shift1=max(6, bitDepth-6).

Then, the auto- and cross-correlation of the gradients, S₁, S₂, S₃, S₅ and S₆, are calculated as:

$${S}_{1} = {\sum }_{( i , j ) ∈ Ω} Abs ( {ψ}_{x} ( i , j ) ) , {S}_{3} = {\sum }_{( i , j ) ∈ Ω} θ ( i , j ) \cdot Sign ( {ψ}_{x} ( i , j ) )$$

$${S}_{2} = {\sum }_{( i , j ) ∈ Ω} {ψ}_{x} ( i , j ) \cdot Sign ( {ψ}_{y} ( i , j ) )$$

$${S}_{5} = {\sum }_{( i , j ) ∈ Ω} Abs ( {ψ}_{y} ( i , j ) ) , {S}_{6} = {\sum }_{( i , j ) ∈ Ω} θ ( i , j ) \cdot Sign ( {ψ}_{y} ( i , j ) )$$

$$where$$

$${ψ}_{x} ( i , j ) = ( \frac{\partial {I}^{( 1 )}}{\partial x} ( i , j ) + \frac{\partial {I}^{( 0 )}}{\partial x} ( i , j ) ) ≫ {n}_{a}$$

$${ψ}_{y} ( i , j ) = ( \frac{\partial {I}^{( 1 )}}{\partial y} ( i , j ) + \frac{\partial {I}^{( 0 )}}{\partial y} ( i , j ) ) ≫ {n}_{a}$$

$$θ ( i , j ) = ( {I}^{( 1 )} ( i , j ) ≫ {n}_{b} ) - ( {I}^{( 0 )} ( i , j ) ≫ {n}_{b} )$$

where Ω is a 6×6 window around the 4×4 subblock, and the values of nₐ and n_{b} are set equal to min(1, bitDepth—11) and min(4, bitDepth—8), respectively.

The motion refinement (νₓ, ν_{y}) is then derived using the cross- and auto-correlation terms using the following:

$${v}_{x} = {S}_{1} > 0 ? clip 3 ( - {th}_{BIO}^{′} , {th}_{BIO}^{′} , - ( ( {S}_{3} \cdot {2}^{{n}_{b} - {n}_{a}} ) ≫ ⌊ {log}_{2} {S}_{1} ⌋ ) ) : 0$$

$${v}_{y} = {S}_{5} > 0 ? clip 3 ( - {th}_{BIO}^{′} , {th}_{BIO}^{′} , - ( ( {S}_{6} \cdot {2}^{{n}_{b} - {n}_{a}} - ( ( {v}_{x} {S}_{2 , m} ) ≪ {n}_{{S}_{2}} + {v}_{x} {S}_{2 , s} ) / 2 ) ≫ ⌊ {log}_{2} {S}_{5} ⌋ ) ) : 0$$

where

$${S}_{2 , m} = {S}_{2} ≫ {n}_{{S}_{2}} , {S}_{2 , s} = {S}_{2} \& ( {2}^{{n}_{{S}_{2}}} - 1 ) , {th}_{BIO}^{′} = {2}^{max ( 5 , B D - 7 )} .$$

[·] is the floor function, and nₛ_{₂}=12. Based on the motion refinement and the gradients, the following adjustment is calculated for each sample in the 4×4 subblock:

$$b ( x , y ) = rnd ( ( {v}_{x} ( \frac{\partial {I}^{( 1 )} ( x , y )}{\partial x} - \frac{\partial {I}^{( 0 )} ( x , y )}{\partial x} ) + {v}_{y} ( \frac{\partial {I}^{( 1 )} ( x , y )}{\partial y} - \frac{\partial {I}^{( 0 )} ( x , y )}{\partial y} ) + 1 ) / 2 )$$

Finally, the BDOF samples of the CU are calculated by adjusting the bi-prediction samples as follows:

$$p r e {d}_{B D O F} ( x , y ) = ( {I}^{( 0 )} ( x , y ) + {I}^{( 1 )} ( x , y ) + b ( x , y ) + {o}_{offset} ) ≫ shift$$

These values are selected such that the multipliers in the BDOF process do not exceed 15-bit, and the maximum bit-width of the intermediate parameters in the BDOF process is kept within 32-bit.

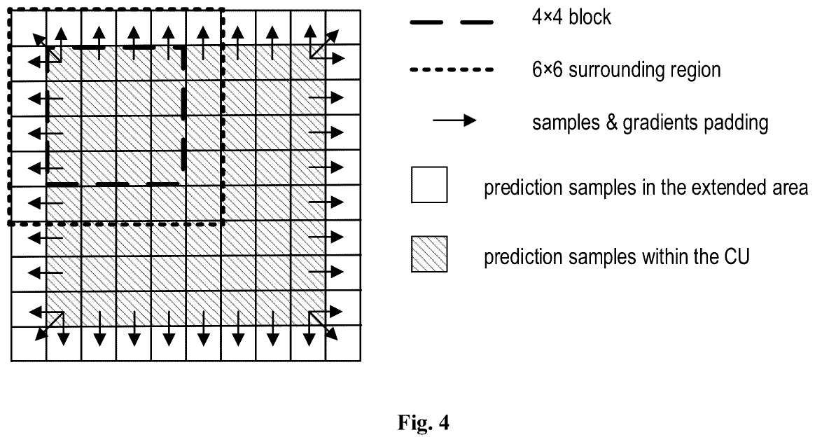

In order to derive the gradient values, some prediction samples I^{(k)}(i, j) in list k (k=0,1) outside of the current CU boundaries need to be generated. As depicted in FIG. 4, the BDOF in VVC uses one extended row/column around the CU's boundaries. In order to control the computational complexity of generating the out-of-boundary prediction samples, prediction samples in the extended area (white positions) are generated by taking the reference samples at the nearby integer positions (using floor( ) operation on the coordinates) directly without interpolation, and the normal 8-tap motion compensation interpolation filter is used to generate prediction samples within the CU (gray positions). These extended sample values are used in gradient calculation only. For the remaining steps in the BDOF process, if any sample and gradient values outside of the CU boundaries are needed, they are padded (i.e. repeated) from their nearest neighbors.

When the width and/or height of a CU are larger than 16 luma samples, it will be split into subblocks with width and/or height equal to 16 luma samples, and the subblock boundaries are treated as the CU boundaries in the BDOF process. The maximum unit size for BDOF process is limited to 16×16. For each subblock, the BDOF process could skipped. When the SAD of between the initial L0 and L1 prediction samples is smaller than a threshold, the BDOF process is not applied to the subblock. The threshold is set equal to (8*W*(H>>1), where W indicates the subblock width, and H indicates subblock height. To avoid the additional complexity of SAD calculation, the SAD between the initial L0 and L1 prediction samples calculated in DVMR process is re-used here.

If BCW is enabled for the current block, i.e., the BCW weight index indicates unequal weight, then bi-directional optical flow is disabled. Similarly, if WP is enabled for the current block, i.e., the luma_weight_1x_flag is 1 for either of the two reference pictures, then BDOF is also disabled. When a CU is coded with symmetric MVD mode or CIIP mode, BDOF is also disabled.

### 2.1.1 BDOF in ECM: Sample-Based BDOF

In the sample based BDOF, instead of deriving motion refinement (Vx, Vy) on a block basis, it is performed per sample.

The coding block is divided into 8×8 subblocks. For each subblock, whether to apply BDOF or not is determined by checking the SAD between the two reference subblocks against a threshold. If decided to apply BDOF to a subblock, for every sample in the subblock, a sliding 5×5 window is used and the existing BDOF process is applied for every sliding window to derive Vx and Vy. The derived motion refinement (Vx, Vy) is applied to adjust the bi-predicted sample value for the center sample of the window.

### 2.2 Decoder Side Motion Vector Refinement (DMVR) in VVC

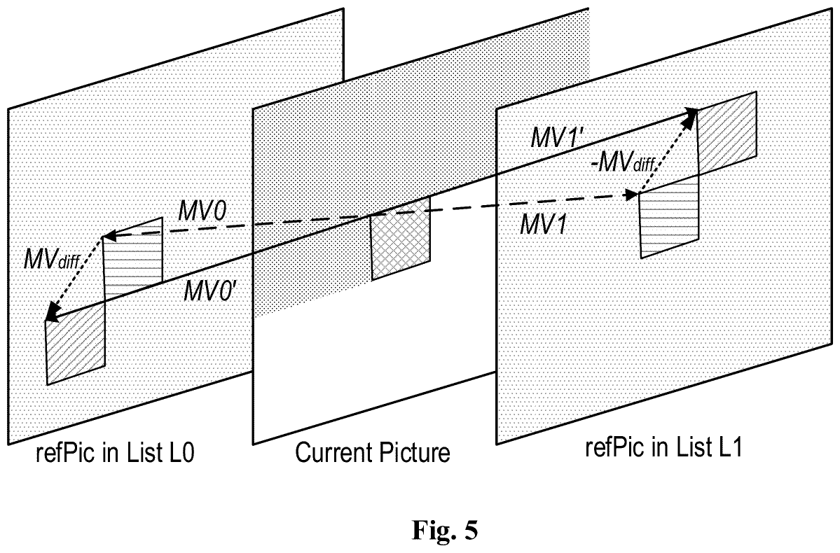

In order to increase the accuracy of the MVs of the merge mode, a bilateral-matching (BM) based decoder side motion vector refinement is applied in VVC. In bi-prediction operation, a refined MV is searched around the initial MVs in the reference picture list L0 and reference picture list L1. The BM method calculates the distortion between the two candidate blocks in the reference picture list L0 and list L1. As illustrated in FIG. 5, the SAD between the red blocks based on each MV candidate around the initial MV is calculated. The MV candidate with the lowest SAD becomes the refined MV and used to generate the bi-predicted signal.

In VVC, the application of DMVR is restricted and is only applied for the CUs which are coded with following modes and features:
CU level merge mode with bi-prediction MV.
One reference picture is in the past and another reference picture is in the future with respect to the current picture.
The distances (i.e., POC difference) from two reference pictures to the current picture are same.
Both reference pictures are short-term reference pictures.
CU has more than 64 luma samples.
Both CU height and CU width are larger than or equal to 8 luma samples.
BCW weight index indicates equal weight.
WP is not enabled for the current block.
CIIP mode is not used for the current block.

The refined MV derived by DMVR process is used to generate the inter prediction samples and also used in temporal motion vector prediction for future pictures coding. While the original MV is used in deblocking process and also used in spatial motion vector prediction for future CU coding.

The additional features of DMVR are mentioned in the following sub-clauses.

In DVMR, the search points are surrounding the initial MV and the MV offset obey the MV difference mirroring rule. In other words, any points that are checked by DMVR, denoted by candidate MV pair (MV0, MV1) obey the following two equations.

$$MV {0}^{′} = MV 0 + MV\_offset$$

$$MV {1}^{′} = MV 1 - MV\_offset$$

Where MV_offset represents the refinement offset between the initial MV and the refined MV in one of the reference pictures. The refinement search range is two integer luma samples from the initial MV. The searching includes the integer sample offset search stage and fractional sample refinement stage.

25 points full search is applied for integer sample offset searching. The SAD of the initial MV pair is first calculated. If the SAD of the initial MV pair is smaller than a threshold, the integer sample stage of DMVR is terminated. Otherwise SADs of the remaining 24 points are calculated and checked in raster scanning order. The point with the smallest SAD is selected as the output of integer sample offset searching stage. To reduce the penalty of the uncertainty of DMVR refinement, it is proposed to favor the original MV during the DMVR process. The SAD between the reference blocks referred by the initial MV candidates is decreased by ¼ of the SAD value.

The integer sample search is followed by fractional sample refinement. To save the calculational complexity, the fractional sample refinement is derived by using parametric error surface equation, instead of additional search with SAD comparison. The fractional sample refinement is conditionally invoked based on the output of the integer sample search stage. When the integer sample search stage is terminated with center having the smallest SAD in either the first iteration or the second iteration search, the fractional sample refinement is further applied.

In parametric error surface based sub-pixel offsets estimation, the center position cost and the costs at four neighboring positions from the center are used to fit a 2-D parabolic error surface equation of the following form

$$E ( x , y ) = {A ( x - {x}_{min} )}^{2} + {B ( y - {y}_{min} )}^{2} + C$$

where (xₘᵢₙ,yₘᵢₙ) corresponds to the fractional position with the least cost and C corresponds to the minimum cost value. By solving the above equations by using the cost value of the five search points, the (xₘᵢₙ,yₘᵢₙ) is computed as:

$${x}_{min} = ( E ( - 1 , 0 ) - E ( 1 , 0 ) ) / ( 2 ( E ( - 1 , 0 ) + E ( 1 , 0 ) - 2 E ( 0 , 0 ) ) )$$

$${y}_{min} = ( E ( 0 , - 1 ) - E ( 0 , 1 ) ) / ( 2 ( ( E ( 0 , - 1 ) + E ( 0 , 1 ) - 2 E ( 0 , 0 ) ) )$$

The value of xₘᵢₙ and yₘᵢₙ are automatically constrained to be between −8 and 8 since all cost values are positive and the smallest value is E(0,0). This corresponds to half peal offset with 1/16th-pel MV accuracy in VVC. The computed fractional (xₘᵢₙ, yₘᵢₙ) are added to the integer distance refinement MV to get the sub-pixel accurate refinement delta MV.

In VVC, the resolution of the MVs is 1/16 luma samples. The samples at the fractional position are interpolated using a 8-tap interpolation filter. In DMVR, the search points are surrounding the initial fractional-pel MV with integer sample offset, therefore the samples of those fractional position need to be interpolated for DMVR search process. To reduce the calculation complexity, the bi-linear interpolation filter is used to generate the fractional samples for the searching process in DMVR. Another important effect is that by using bi-linear filter is that with 2-sample search range, the DVMR does not access more reference samples compared to the normal motion compensation process. After the refined MV is attained with DMVR search process, the normal 8-tap interpolation filter is applied to generate the final prediction. In order to not access more reference samples to normal MC process, the samples, which is not needed for the interpolation process based on the original MV but is needed for the interpolation process based on the refined MV, will be padded from those available samples. When the width and/or height of a CU are larger than 16 luma samples, it will be further split into subblocks with width and/or height equal to 16 luma samples. The maximum unit size for DMVR searching process is limit to 16×16.

### 2.3. Multi-Pass Decoder-Side Motion Vector Refinement (ECM)

A multi-pass decoder-side motion vector refinement is applied. In the first pass, bilateral matching (BM) is applied to the coding block. In the second pass, BM is applied to each 16×16 subblock within the coding block.

In the third pass, MV in each 8×8 subblock is refined by applying bi-directional optical flow (BDOF). The refined MVs are stored for both spatial and temporal motion vector prediction.

### 2.3.1 First Pass—Block Based Bilateral Matching MV Refinement

In the first pass, a refined MV is derived by applying BM to a coding block. Similar to decoder-side motion vector refinement (DMVR), in bi-prediction operation, a refined MV is searched around the two initial MVs (MV0 and MV1) in the reference picture lists L0 and L1. The refined MVs (MV0_pass1 and MV1_pass1) are derived around the initiate MVs based on the minimum bilateral matching cost between the two reference blocks in L0 and L1.

BM performs local search to derive integer sample precision intDeltaMV. The local search applies a 3×3 square search pattern to loop through the search range [−sHor, sHor] in horizontal direction and [−sVer, sVer] in vertical direction, wherein, the values of sHor and sVer are determined by the block dimension, and the maximum value of sHor and sVer is 8.

The bilateral matching cost is calculated as: bilCost=mvDistanceCost+sadCost. When the block size cbW*cbH is greater than 64, mean-removal SAD (MRSAD) cost function is applied to remove the DC effect of distortion between reference blocks. When the bilCost at the center point of the 3×3 search pattern has the minimum cost, the intDeltaMV local search is terminated. Otherwise, the current minimum cost search point becomes the new center point of the 3×3 search pattern and continue to search for the minimum cost, until it reaches the end of the search range.

The existing fractional sample refinement is further applied to derive the final deltaMV. The refined MVs after the first pass is then derived as:

$$MV0\_pass1 = MV 0 + deltaMV ,$$

$$MV1\_pass1 = MV 1 - deltaMV .$$

### 2.3.2 Second Pass—Subblock Based Bilateral Matching MV Refinement

In the second pass, a refined MV is derived by applying BM to a 16×16 grid subblock. For each subblock, a refined MV is searched around the two MVs (MV_pass1 and MV1_pass1), obtained on the first pass, in the reference picture list L0 and L1. The refined MVs (MV0_pass2(sbIdx2) and MV1_pass2(sbIdx2)) are derived based on the minimum bilateral matching cost between the two reference subblocks in L0 and L1.

For each subblock, BM performs full search to derive integer sample precision intDeltaMV. The full search has a search range [−sHor, sHor] in horizontal direction and [−sVer, sVer] in vertical direction, wherein, the values of sHor and sVer are determined by the block dimension, and the maximum value of sHor and sVer is 8.

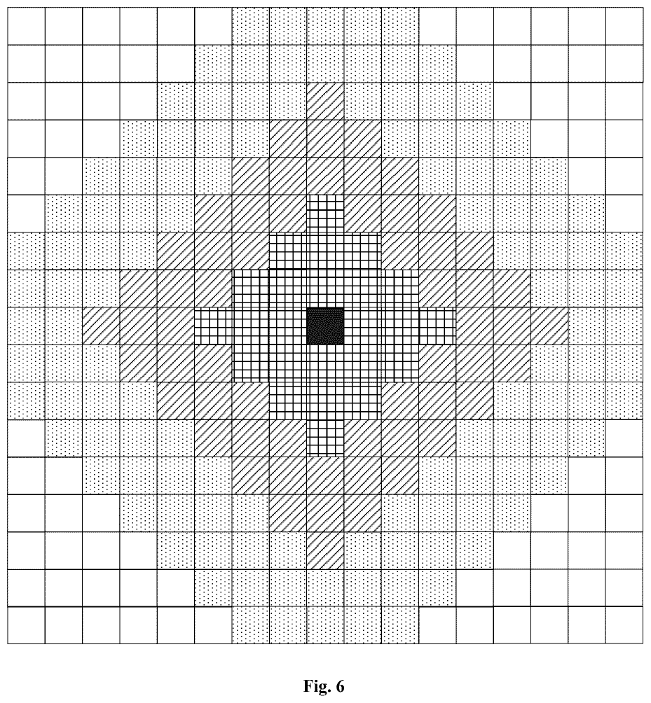

The bilateral matching cost is calculated by applying a cost factor to the SATD cost between two reference subblocks, as: bilCost=satdCost*costFactor. The search area (2*sHor+1)*(2*sVer+1) is divided up to 5 diamond shape search regions shown on FIG. 6. Each search region is assigned a costFactor, which is determined by the distance (intDeltaMV) between each search point and the starting MV, and each diamond region is processed in the order starting from the center of the search area. In each region, the search points are processed in the raster scan order starting from the top left going to the bottom right corner of the region. When the minimum bilCost within the current search region is less than a threshold equal to sbW*sbH, the int-pel full search is terminated, otherwise, the int-pel full search continues to the next search region until all search points are examined. Additionally, if the difference between the previous minimum cost and the current minimum cost in the iteration is less than a threshold that is equal to the area of the block, the search process terminates.

The existing VVC DMVR fractional sample refinement is further applied to derive the final deltaMV(sbIdx2).

The refined MVs at second pass is then derived as:

$$MV0\_pass2 ( s b Idx 2 ) = MV0\_pass1 + d e l t a M V ( s b Idx 2 )$$

$$MV1\_pass2 ( sb Idx 2 ) = MV1\_pass1 - deltaM V ( s b Idx 2 ) .$$

### 2.3.3 Third Pass—Subblock Based Bi-Directional Optical Flow MV Refinement

In the third pass, a refined MV is derived by applying BDOF to an 8×8 grid subblock. For each 8×8 subblock, BDOF refinement is applied to derive scaled Vx and Vy without clipping starting from the refined MV of the parent subblock of the second pass. The derived bioMv(Vx, Vy) is rounded to 1/16 sample precision and clipped between −32 and 32.

The refined MVs (MV0_pass3(sbIdx3) and MV1_pass3(sbIdx3)) at third pass are derived as:

$$MV0\_pass3 ( s b Idx 3 ) = MV0\_pass2 ( s b Idx 2 ) + bioMv ,$$

$$MV1\_pass3 ( sb Idx 3 ) = MV0\_pass2 ( s b Idx 2 ) - bioMv .$$

In all aforementioned sub-clauses, when wrap around motion compensation is enabled, the motion vectors shall be clipped with wrap around offset taken into consideration.

### 2.3.4 Adaptive Decoder-Side Motion Vector Refinement

Adaptive decoder side motion vector refinement method is an extension of multi-pass DMVR which consists of the two new merge modes to refine MV only in one direction, either L0 or L1, of the bi prediction for the merge candidates that meet the DMVR conditions. The multi-pass DMVR process is applied for the selected merge candidate to refine the motion vectors, however either MVD0 or MVD1 is set to zero in the 1^{st} pass (i.e., PU level) DMVR.

The merge candidates for the new merge mode are derived from spatial neighboring coded blocks, TMVPs, non-adjacent blocks, HMVPs, pair-wise candidate, similar as in the regular merge mode. The difference is that only those meet DMVR conditions are added into the candidate list. The same merge candidate list is used by the two new merge modes. If the list of BM candidates contains the inherited BCW weights and DMVR process is unchanged except the computation of the distortion is made using MRSAD or MRSATD if the weights are non-equal and the bi-prediction is weighted with BCW weights. Merge index is coded as in regular merge mode.

### 3. Problems

There are several parts in the BDOF MV refinement/sample adjustment may be improved.
The current formulas which is used to drive BDOF parameters, are not accurate formulas.
There are no weights to indicate the importance of each sample in the final formula.
There is no filtering process to smooth out the final derived MV refinement/sample adjustment.
There is no clear distinction for conditions of applying BDOF for MV refinement/sample adjustment.

Similarly, no distinction for their formula.

### 4. Detailed Solutions

The detailed solutions below should be considered as examples to explain general concepts. These solutions should not be interpreted in a narrow way. Furthermore, these solutions can be combined in any manner.

The methods disclosed below may be applied to bi-directional optical flow, decoder side motion vector refinement, and any extensions of them.

### On BDOF MV Refinement Parameter Derivation

In the following section general equation for deriving BDOF parameters (vx and vy) is defined as:

$$Σ Gx \cdot Gx * vx + Σ Gx \cdot Gy * vy = Σ dI \cdot Gx \cdot \to s 1 * vx + s 2 * vy = s 3 ,$$

$$Σ Gx \cdot Gy * vx + Σ Gy \cdot Gy * vy = Σ dI \cdot Gy \to s 2 * vx + s 5 * vy = s 6 ,$$

where, Gx and Gy represents summation of horizontal and vertical gradients for 2 reference pictures, respectively. dI represents the difference between 2 reference pictures. Summations (Σ) are inside of the predefined area, which could be an N×M block around current sample (for sample adjustment BDOF), or around the current prediction subblock (for MV refinement BDOF).
1. It is proposed that a method of deriving gradients different to that of BDOF in VVC may be used to calculate horizontal and/or vertical gradients.
   a. In one example gradients are computed by directly calculating the difference between two neighboring samples, i.e.,

$$\frac{\partial {I}^{( k )}}{\partial x} ( i , j ) = ( ( {I}^{( k )} ( i + 1 , j ) ≫ 1 ) - ( {I}^{( k )} ( i - 1 , j ) ≫ 1 ) )$$

$$\frac{\partial {I}^{( k )}}{\partial y} ( i , j ) = ( ( {I}^{( k )} ( i , j + 1 ) ≫ 1 ) - ( {I}^{( k )} ( i , j - 1 ) ≫ 1 ) )$$

b. In another example gradients are computed by calculating the difference between two shifted neighboring samples, i.e.,

$$\frac{\partial {I}^{( k )}}{\partial x} ( i , j ) = ( ( {I}^{( k )} ( i + 1 , j ) ≫ shift 1 ) - ( {I}^{( k )} ( i - 1 , j ) ≫ shift 1 ) )$$

$$\frac{\partial {I}^{( k )}}{\partial y} ( i , j ) = ( ( {I}^{( k )} ( i , j + 1 ) ≫ shift 2 ) - ( {I}^{( k )} ( i , j - 1 ) ≫ shift 2 ) )$$

i. shift1 and shift2 may be any integers such as 0, 1, 2, 6, . . . or even negative integers.
c. In another example gradients may be calculated with Nb samples before and Na samples after current samples as a weighted sum:

$$\frac{\partial {I}^{( k )}}{\partial x} ( i , j ) = {\sum }_{p = - Nb}^{Na} wp * {I}^{( k )} ( i + p , j )$$

$$\frac{\partial {I}^{( k )}}{\partial y} ( i , j ) = {\sum }_{p = - Nb}^{Na} wp * {I}^{( k )} ( i , j + p )$$

i. Weights, i.e., wp, may be any integer number such as −6, 0, 2, 7 . . . or any real number such as −6.3, −0.77, 0.1, 3.0, . . .
ii. Weights for calculating horizontal and vertical gradients may be different from each other.
   (i) Alternatively, the weights for calculating horizontal and vertical gradients may be the same.
iii. Weights may be signaled from an encoder to a decoder.
iv. Weights may be derived using information decoded.
v. Nb and Na may be any integer numbers such as 0, 3, 10, . . .
vi. Nb and Na may be different for calculating gradients for horizontal and vertical directions.
   (i) Alternatively, they may be the same for calculating gradients for both horizontal and vertical directions.
vii. In one example,

$$\frac{\partial {I}^{( k )}}{\partial x} ( i , j ) = ( {\sum }_{p = - Nb}^{Na} wp * {I}^{( k )} ( i + p , j ) + Offset ) ≫ shift$$

$$\frac{\partial {I}^{( k )}}{\partial y} ( i , j ) = ( {\sum }_{p = - Nb}^{Na} wp * {I}^{( k )} ( i , j + p ) + Offset ) ≫ shift$$

(i) alternatively, furthermore, the variable offset may be set to 0, or (1<<(shift-1)).
2. It is proposed that a complete linear equation formula may be used to derive the final MV refinement.
   a. In one example after calculating all the gradients, s1, s2, s3, s5, and s6 are calculated as explained above:

$$\sum Gx \cdot Gx * vx + \sum Gx \cdot Gy * vy = \sum dI \cdot Gx \cdot \to s 1 * vx + s 2 * vy = s 3 ,$$

$$\sum Gx \cdot Gy * vx + \sum Gy \cdot Gy * vy = \sum dI \cdot Gy \to s 2 * vx + s 5 * vy = s 6.$$

i. In one example, to derive the final MV of a M*N block, samples in a (M+K1)*(N+K2) region around the original block may be involved. For example, K1 and K2 may be any integer numbers such as 0, 2, 4, 7, 10, . . .
b. In one example after calculating all the s1, s2, s3, s5, and s6, the determinate values, D, Dx, and Dy are calculated as:

$$D = ( s 1 ≫ shTem ) * ( s 5 ≫ shTem ) - ( s 2 ≫ shTem ) * ( s 2 ≫ shTem ) ,$$

$$Dx = ( s 3 ≫ shTem ) * ( s 5 ≫ shTem ) - ( s 6 ≫ shTem ) * ( s 2 ≫ shTem ) ,$$

$$Dy = ( s 1 ≫ shTem ) * ( s 6 ≫ shTem ) - ( s 3 ≫ shTem ) * ( s 2 ≫ shTem ) .$$

i. In one example shTem maybe any integer number such as 0, 1, 3, . . .
c. In one example after calculating D, Dx, and Dy; vx and vy may be derived as:

$$vx = Dx / D and vy = Dy / D .$$

i. In another example if abs(D) is smaller than a predefined threshold, C, vx and vy are set to zero. C may be any non-negative number such as 0, 10, 17, . . .
d. In one example any amount of the shifts and clipping may be involved to derive the final vx and vy.
   i. In one example the numerator and/or denominator, may have an extra shift, in a way that overall, it is left shifted by K so that the final derived vx and vy have higher precision. K may be any integer number such as 0, 1, 3, 4, 6, . . .
   ii. In one example these shifts may come in any order, such as having the shifts at the beginning, and/or having the shift for intermediate variables and/or having the shift on the final MVs.
   iii. In one example the final vx and vy may be clipped between −B and B, where B may be any integer number such as 2, 10, 17, 32, 100, 156, 725, . . .
e. In one example the final vx and vy may be multiplied (or similarly divided) by a number before getting used for motion compensation procedure.
   i. In one example vx and vy may be multiplied by R, where R is any real number, such as 1.25, 2, 3.1, 4, . . .
   ii. In another example vx and vy may be divided by R, where R is any real number, such as 1.25, 2, 3.1, 4, . . .
   iii. In one example the value of the number to multiply (or divide) the final vx, vy with may be different for vx and vy.
   iv. In one example the value of the number to multiply (or divide) the final vx, vy, may depend on the block size, sequence resolution, block characteristics, and so on.
3. It is proposed that a partial linear equation solution may be used to derive the final MV refinement.
   a. In one example after calculating all the gradients, s1, s2, s3, s5, and s6 are calculated as explained above:

$$\sum Gx \cdot Gx * vx + \sum Gx \cdot Gy * vy = \sum dI \cdot Gx \cdot \to s 1 * vx + s 2 * vy = s 3 ,$$

$$\sum Gx \cdot Gy * vx + \sum Gy \cdot Gy * vy = \sum dI \cdot Gy \to s 2 * vx + s 5 * vy = s 6.$$

b. In one example after calculating all the s1, s2, s3, s5, and s6, approximated version of vx and vy may be calculated as:

$$vx = s 3 / s 1 ,$$

$$vy = ( s 6 - s 2 * vx ) / s 5.$$

c. In another example after calculating vx similar to above, partial amount of the vx may be put in the second formula to derive the vy.
   i. In one example vy may be derived as vy=(s6−s2*vx/T)/s5, where T may be any real number such as 1.1, 2, 4, . . .
d. In one example after calculating all the s1, s2, s3, s5, and s6, approximated version of vx and vy may be calculated as:

$$Assume vx is zero : vy = s 6 / s 5 ,$$

$$Insert vy in the first formula : vx = ( s 3 - s 2 * vy ) / s 1.$$

e. In another example after calculating vy similar to above, partial amount of the vy may be inserted in the second formula to derive the vx.
   i. In one example vx may be derived as vx=(s3−s2*vy/T)/s1, where T may be any real number such as 1.1, 2, 4, . . .
f. In one example after calculating all the s1, s2, s3, s5, and s6, approximated version of vx and vy may be calculated as:

$$Assume vy is zero : vx = s 3 / s 1.$$

$$Assume vx is zero : vy = s 6 / s 5.$$

4. It is proposed that a simplified solution may be used to derive the final MV refinement.
   a. In one example the method explained in the background section for VVC BDOF may be used to derive the approximated version of s1, s2, s3, s5, and s6.
   b. In one example after calculating approximated version of the s1, s2, s3, s5, and s6, the determinate values, D, Dx, and Dy are calculated as:

$$D = ( s 1 ≫ shTem ) * ( s 5 ≫ shTem ) - ( s 2 ≫ shTem ) * ( s 2 ≫ shTem ) ,$$

$$Dx = ( s 3 ≫ shTem ) * ( s 5 ≫ shTem ) - ( s 6 ≫ shTem ) * ( s 2 ≫ shTem ) ,$$

$$Dy = ( s 1 ≫ shTem ) * ( s 6 ≫ shTem ) - ( s 3 ≫ shTem ) * ( s 2 ≫ shTem ) .$$

i. In one example after calculating D, Dx, and Dy; vx and vy may be derived as:

$$vx = Dx / D and vy = Dy / D .$$

ii. In one example shTem maybe any integer number such as 0, 1, 3, . . .
c. In one example after calculating approximated version of the s1, s2, s3, s5, and s6, approximated version of vx and vy may be calculated as:

$$Assume vy is zero : vx = s 3 / s 1 ,$$

$$Substitute vx in the second formula : vy = ( s 6 - s 2 * vx ) / s 5.$$

i. Or alternatively, a modified vx may be inserted in the second formula: vy=(s6−s2*vx/T)/s5, where T may be any real number such as 1.1, 2, 4, . . .
ii. Alternatively, first vx may be assumed zero, and vy may be derived, after that either vy or a scaled version of it may be inserted into the first equation and vx may be derived.
5. It is proposed any combination of the methods explained above may be used to derive the final MV refinement.
   a. In one example any combination of the methods explained above (2, 3, and 4) may be combined and used together.

### On BDOF Sample Adjustment Parameter Derivation

6. It is proposed that any of the method explained above for BDOF MV refinement may also be used for BDOF sample adjustment parameter derivation.
   a. In one example after calculating all the gradients, s1, s2, s3, s5, and s6 are calculated as explained above:

$$\sum Gx \cdot Gx * vx + \sum Gx \cdot Gy * vy = \sum dI \cdot Gx \cdot \to s 1 * vx + s 2 * vy = s 3 ,$$

$$\sum Gx \cdot Gy * vx + \sum Gy \cdot Gy * vy = \sum dI \cdot Gy \to s 2 * vx + s 5 * vy = s 6.$$

i. In one example samples in a K×K region around the sample may be involved in the derivation. K may be any integer number such as 1, 3, 4, 5, 7, 10, . . .
b. In one example after calculating s1, s2, s3, s5, and s6, the determinate values, D, Dx, and Dy are calculated as:

$$D = ( s 1 ≫ shTem ) * ( s 5 ≫ shTem ) - ( s 2 ≫ shTem ) * ( s 2 ≫ shTem ) ,$$

$$Dx = ( s 3 ≫ shTem ) * ( s 5 ≫ shTem ) - ( s 6 ≫ shTem ) * ( s 2 ≫ shTem ) ,$$

$$Dy = ( s 1 ≫ shTem ) * ( s 6 ≫ shTem ) - ( s 3 ≫ shTem ) * ( s 2 ≫ shTem ) .$$

i. shTem maybe any integer number such as 0, 1, 3 . . .
ii. In one example after calculating D, Dx, and Dy; vx and vy may be derived as:

$$vx = Dx / D and vy = Dy / D .$$

iii. In another example if abs(D) is smaller than a predefined threshold, C, vx and vy are set to zero. C may be any non-negative number such as 0, 10, 17, . . .
c. In one example after calculating s1, s2, s3, s5, and s6, approximated version of vx and vy may be calculated as:

$$vx = s 3 / s 1 ,$$

$$vy = ( s 6 - s 2 * vx ) / s 5.$$

i. Or alternatively a modified vx may be put in the second formula: vy=(s6−s2*vx/T)/s5, where T may be any real number such as 1.1, 2, 4, . . .
ii. Alternatively, first vx may be assumed zero, and vy may be derived, after that either vy or a scaled version of it may be substituted into the first equation and vx may be derived.
d. In one example the method explained in the background section for VVC BDOF may be used to derive the approximated version of s1, s2, s3, s5, and s6.
e. In one example the final vx and vy may be multiplied (or divided or shifted) by a number before getting used for sample adjustment procedure.
   i. In one example vx and vy may be multiplied by R, where R is any real number, such as 1.25, 2, 3.1, 4, . . .
   ii. In another example vx and vy may be divided by R, where R is any real number, such as 1.25, 2, 3.1, 4, . . .
   iii. In one example the value of the number to multiply (or divide) the final vx, vy with may be different for vx and vy.
   iv. In one example the value of the number to multiply (or divide) the final vx, vy, may depend on the block size, sequence resolution, block characteristics, position in the block, and so on.

### On Applying Weights in Parameter Derivation

7. It is proposed that any weights may be applied before adding BDOF intermediate parameters for MV refinement.
a. In one example during adding parameters to get s1, s2, s3, s5, and s6, inside of the target region of Ω(a M_ext*N_ext region around the current block), all the values are added with similar weight (of 1).
   b. In another example during adding parameters to get s1, s2, s3, s5, and s6, inside of the target region of Ω(a M_ext*N_ext region around the current block), the values are added after being multiplied with a predefined weight depending on their position in the extended block (target region of Ω).
   c. In one example these predefined weights are defined as:

$$w = ( x >= ( width / 2 ) ? width - x : x + 1 ) * ( y >= ( height / 2 ) ? height - y : y + 1 )$$

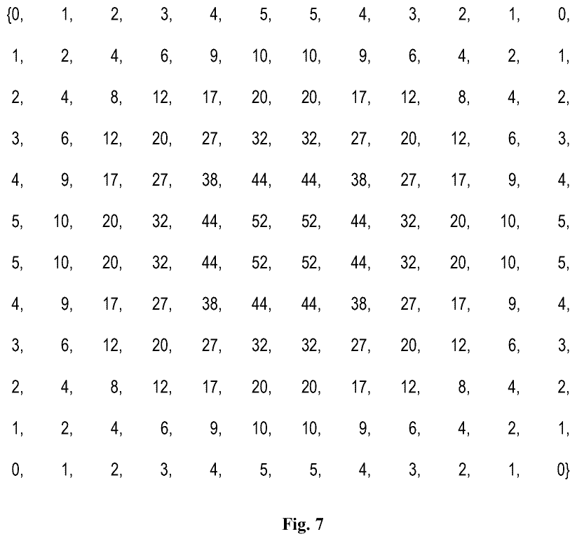

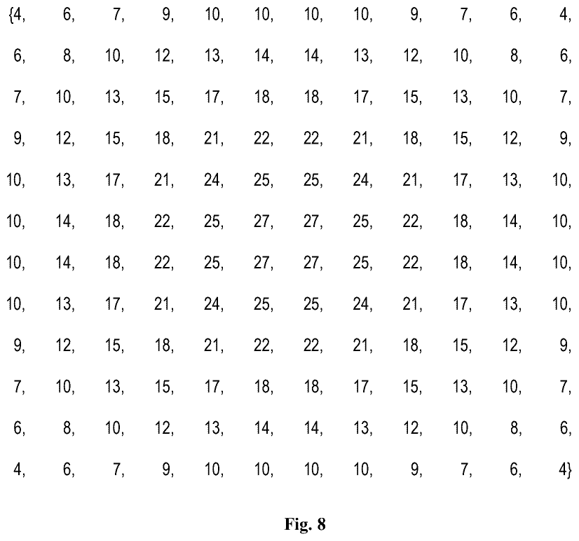

for x from 0 to width −1 and y from 0 to height −1.
Width and height represent the width and height of the target region.
d. In another example these predefined weights may be generated with some known probability distribution such as Gaussian distribution with any value of the standard deviations (σ=1, 1.5, 4, or any other real number) and center position.
   i. In one example these weights are generated with Gaussian distribution with σ=2.5 for a 12×12 region as depicted in FIG. 7.
   ii. In one example these weights are generated with Gaussian distribution with σ=4 for a 12×12 region as depicted in FIG. 8.
e. In another example during adding parameters to get s1, s2, s3, s5, and s6, inside of the target region of Ω(a M_ext*N_ext region around the current block), the values are added after being shifted with a predefined values depending on their position in the extended block (target region of Ω).
f. In one example the weight matrix may be represented as left (or right) shift matrix, and depending on the matrix entries, the data gets shifted (left or right) before summation.
8. In one example depending on the block size, block shape, block characteristics, sequence resolutions, and so, different weights may be applied.
   i. Or alternatively depending on the block size, block shape, block characteristics, sequence resolutions, and so on, no weight may be applied.
   ii. The weight matrix may be coded explicitly in sequence parameter set (SPS), picture parameter set (PPS), or slice header (SH).
9. It is proposed that any weights may be applied before adding BDOF intermediate parameters for sample adjustment.
   a. In one example during adding parameters to get s1, s2, s3, s5, and s6, inside of the target region of Ω(a K1*K2 region around the current sample), all the values are added with similar weight (of 1). K1 and K2 may be any integer number such as 1, 2, 3, 5, 8, . . .
   b. In another example during adding parameters to get s1, s2, s3, s5, and s6, inside of the target region of Ω(a K1*K2 region around the current sample), the values are added after being multiplied with a predefined weight depending on their position in the extended block (target region of Ω).
   c. In one example these predefined weights are defined as:

$$w = ( x >= ( K 1 / 2 ) ? K 1 - x : x + 1 ) * ( y >= ( K 2 / 2 ) ? K 2 - y : y + 1 ) ,$$

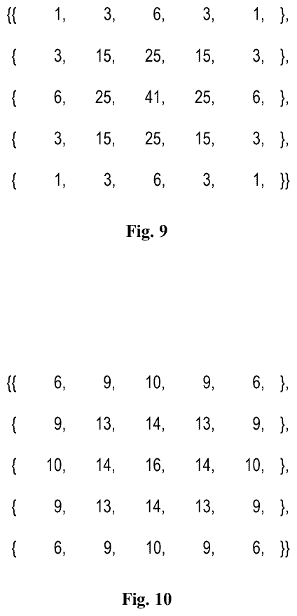

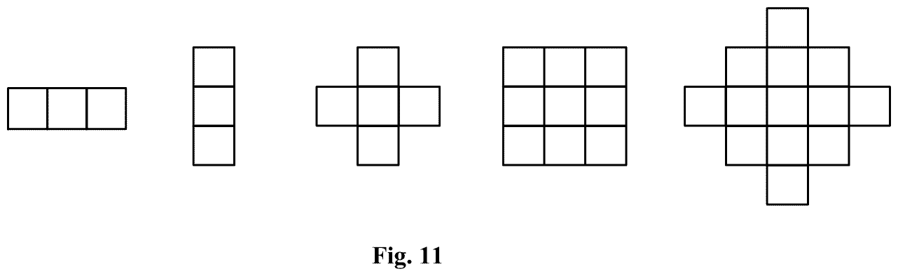

for x from 0 to K1−1 and y from 0 to K2−1.
K1 and K2 represent the width and height of the target region.
d. In another example these predefined weights may be generated with some known probability distribution such as Gaussian distribution with any value of the standard deviations (σ=1, 1.5, 2, 4, or any other real number) and any center position.
   i. In one example these weights are generated with Gaussian distribution with σ=1 for a 5×5 region as depicted in FIG. 9.
   ii. In one example these weights are generated with Gaussian distribution with σ=2 for a 5×5 region as depicted in FIG. 10.
e. In one example the weight matrix may be represented as a left (or right) shift matrix, and depending on the matrix entries, the data gets shifted (left or right) before summation.
f. In one example depending on the block size, block shape, block characteristics, sequence resolutions, and so, different weights may be applied.
   i. Or alternatively depending on the block size, block shape, block characteristics, sequence resolutions, and so on, no weight may be applied.

### On Applying Filters on the Final MV Refinement or Sample Adjustment

10. It is proposed that any type of the filters may be applied on the final derived MV refinement (vx and vy). Some examples are depicted in FIG. 11.
   a. In one example any smoothing filter of any shape may be applied on all the MVs derived by BDOF for each subblock.
   b. In one example during filter application all the MVs inside of the PU may be used.
   c. In another example during filter application, only MVs with similar 2^{nd} round of DMVR MVs, may be used for those MVs.
   d. In one example a shape filter with any weights may be applied on the MVs.
      i. In one stance the weight for the center may be 8, and the weight for 4 sides may be 1.
      ii. In one stance the weight for the center may be 4, and the weight for 4 sides may be 1.
      iii. In one stance the weight for the center may be 4, and the weight for 4 sides may be 2.
      iv. In one stance the weight for the center may be 4, and the weight for 4 sides may be 3.
      v. In one stance the weight for the center may be 1, and the weight for 4 sides may be 1.
11. It is proposed that any type of the filters may be applied on the final derived BDOF sample MV adjustment, or final sample adjustment. Some examples are depicted in FIG. 11.
   a. In one example filter is applied on all (vx,vy)s or final adjustment inside of the subblock.
   b. In one example, a shape filter with any weights may be applied on the (vx,vy)s or final adjustment.
      i. In one stance the weight for the center may be 8, and the weight for 4 sides may be 1.
      ii. In one stance the weight for the center may be 4, and the weight for 4 sides may be 1.
      iii. In one stance the weight for the center may be 4, and the weight for 4 sides may be 2.
      iv. In one stance the weight for the center may be 4, and the weight for 4 sides may be 3.
      v. In one stance the weight for the center may be 1, and the weight for 4 sides may be 1.

### On Conditions for Applying BDOF

12. It is proposed that there may be a condition on applying BDOF MV refinement or BDOF sample adjustment.
   a. In one example the condition of applying BDOF MV refinement may be similar to the condition of applying BDOF sample adjustment.
   b. In another example, the condition of applying BDOF MV refinement may be different of the condition of applying BDOF sample adjustment. For example, BDOF MV refinement may be applied to bi-prediction coded CU with un-equal weight, while BDOF sample adjustment may only be applied to bi-prediction coded CU with equal weight.
13. It is proposed that the cost for evaluating the BDOF condition may depend on a cost between 2 reference picture blocks.
   a. In one example different cost functions may be used to derive the cost.
      i. In one example this cost may be Sum of Absolute Difference (SAD) between the 2 reference picture blocks.
      ii. In one example this cost may be Sum of Absolute Transformed Difference (SATD) or any other cost measure between the 2 reference picture blocks.
      iii. In one example this cost may be Mean Removal based Sum of Absolute Difference (MR-SAD) between the 2 reference picture blocks.
      iv. In one example this cost may be a weighted average of SAD/MR-SAD and SATD between the 2 reference picture blocks.
      v. In one example, the cost function between 2 reference picture blocks may be:
         (i) Sum of absolute differences (SAD)/mean-removal SAD (MR-SAD);
         (ii) Sum of absolute transformed differences (SATD)/mean-removal SATD (MR-SATD);
         (iii) Sum of squared differences (SSD)/mean-removal SSD (MR-SSD);
         (iv) SSE/MR-SSE;
         (v) Weighted SAD/weighted MR-SAD;
         (vi) Weighted SATD/weighted MR-SATD;
         (vii) Weighted SSD/weighted MR-SSD;
         (viii) Weighted SSE/weighted MR-SSE;
         (ix) Gradient information.

### On BDOF MV Refinement Subblock Size

14. It is proposed any subblock size, depending on the conditions, may be used as BDOF MV refinement subblock size.
   a. In one example subblock size may be a fixed size such as N×M, where N and M could be any positive integer, such as 1, 2, 3, 4, 5, 8, 12, 32, . . .
   b. In another example subblock size may depend on the current PU, or CU size. As an example, for block size W×H, subblock size of W1×H1 may be used, where W1 and H1 depend on W and H, and could be any positive integer number.
      i. In one example for blocks with number of samples (i.e., width times height (W*H)) between C_i and C_(i+1), subblock size of W_i×H_i may be used. C_i s could be any non-negative number such as 0, 4, 20, 128, 256, 951, 2048, 4100, . . . and W_i×H_i may be any positive integer pairs such as 2×2, 4×4,8×4, 4×8, 8×8, 16×16, 19×15, . . .
      ii. In one example for blocks with width W, between Cw_i and Cw_(i+1), and height H, between Ch_j and Ch_(j+1), subblock size of W_i×H_j may be used. Cw_i and Ch_j s could be any non-negative numbers such as 0, 4, 20, 128, 256, 951, 2048, 4100, . . . and W_i×H_j may be any positive integer pairs such as 2×2, 4×4,8×4, 4×8, 8×8, 16×16, 19×15, . . .
   c. In one example, the subblock size may depend on the color component and/or color format.
   d. In one example subblock size may depend on the coded information of current block.
      i. In one example, the coded information is the residual information.
      ii. In one example, the coded information is the coding tool that is applied to current block.
   e. In one example subblock size may depend on the information of prediction blocks.
   f. In one example subblock size may depend on the reference pictures characteristics.
      i. In one example, subblock size may be determined by the similarity of two predictors from two reference pictures. If two predictors are similar, such as SAD between these two predictors is small, the larger subblock size may be applied; Otherwise, the small subblock size may be applied.
      ii. In one example, subblock size may be determined by the distribution of the difference between two predictors. Those subblocks with difference energy, such as SAD or SSE, may be merged to a larger unit for MV refinement to reduce the computation complexity.
   g. In one example subblock size may depend on the temporal gradient of the 2 reference blocks.
      i. In one example any cost function such as SAD, may be used for calculating the 2 reference block gradients (or differences).
   h. In one example the spatial gradients of the reference blocks may be used to determine the subblock size.
      i. In one example the subblock size may depend on the Quantization Parameter (qp) value.
      i. In one example for qp less than X, the subblock size of W_X×H_X may be used.
      ii. In one example for qp greater than X, the subblock size of W_X×H_X may be used.
      iii. In one example for qp X, the subblock size of W_X×H_X may be used.
      iv. In one example X may be any non-negative integer such as 10, 22, 27, 32, 37, 42, . . . and W_X and H_X may be any positive integer such as 1, 2, 3, 4, 8, 10, . . .
      v. In one example, qp can be the qp of current CU, or the qp of current slice, or the qp of the whole sequence.
      vi. In one example the decision for subblock size may be a encoder decision and it may or may not be signaled to the decoder. Similarly, it may be a decoder decision.
      vii. In one example increasing or decreasing the subblock size based on qp, may be an encoder or decoder decision.
   j. In one example the subblock size may depend on the prediction type.
   k. In one example the subblock size my depend on the DMVR first and/or 2^{nd} stage adjustment value.
   l. In one example the subblock size may depend on the sequence resolution.
   m. In one example the subblock size may depend on the coding tools applied to current block.
   n. In one example the subblock size may depend on the temporal layers.
      i. In one example for temporal layers between Ti and Tj, subblock size of W_ij×H_ij may be used. Ti, Tj may be any non-negative integer such as 0, 1, 3, 4, . . . , and W_ij, H_ij may be any positive integer such as 2, 4, 6, 16, . . .
   o. In one example the subblock size may be a function of all or some of the parameters mentioned above.
   p. In above examples, the subblock size of luma and/or chroma blocks may be determined according to above examples.
      i. Alternatively, the subblock size for chroma blocks may be derived according to that for luma blocks and color format and/or separate plane coding enabled or not.

### On Asymmetric BDOF

15. It is proposed the MV adjustment for the first list and second list may not be symmetric.
   a. In one example the MV refinement for ref pic 0, may be (vx0, vy0) and the MV refinement for ref pic 1, may be (−vx1, −vy1), where vx0, vy0, vx1, vy1 may be any real or integer numbers. They may or may not have relationship together.
   b. In one example general equations for deriving vx0, vy0, vx1, vy1 may be written as following 4 equations:

$$\sum Gx 0 \cdot Gx 0 * vx 0 + \sum Gx 1 \cdot Gx 0 * vx 1 + \sum Gy 0 \cdot Gx 0 * vy 0 + \sum Gy 1 \cdot Gx 0 * vy 1 = \sum dI \cdot Gx 0.$$

$$\sum Gx 0 \cdot Gx 1 * vx 0 + \sum Gx 1 \cdot Gx 1 * vx 1 + \sum Gy 0 \cdot Gx 1 * vy 0 + \sum Gy 1 \cdot Gx 1 * vy 1 = \sum dI \cdot Gx 1.$$

$$\sum Gx 0 \cdot Gx 0 * vx 0 + \sum Gx 1 \cdot Gx 0 * vx 1 + \sum Gy 0 \cdot Gx 0 * vy 0 + \sum Gy 1 \cdot Gx 0 * vy 1 = \sum dI \cdot Gx 0.$$

$$\sum Gx 0 \cdot Gx 1 * vx 0 + \sum Gx 1 \cdot Gx 1 * vx 1 + \sum Gy 0 \cdot Gx 1 * vy 0 + \sum Gy 1 \cdot Gx 1 * vy 1 = \sum dI \cdot Gx 1.$$

where, Gx0, Gx1, Gy0 and Gy1 represents horizontal gradients for ref pic 0, horizontal gradients for ref pic 1, vertical gradients for ref pic and vertical gradients for ref pic 1 respectively. dI represents the difference between 2 reference pictures. Summations (Σ) are inside of the predefined area, which could be an N×M block around current sample (for sample adjustment BDOF), or around the current prediction subblock (for MV refinement BDOF).
c. Alternatively in a matrix format they may be written as:

$$[ \begin{matrix}{s}_{00} & {s}_{01} & {s}_{02} & {s}_{03} \\ {s}_{10} & {s}_{11} & {s}_{12} & {s}_{13} \\ {s}_{20} & {s}_{21} & {s}_{22} & {s}_{23} \\ {s}_{30} & {s}_{31} & {s}_{32} & {s}_{33}\end{matrix} ] * [ \begin{matrix}vx 0 \\ vx 1 \\ vy 0 \\ vy 1\end{matrix} ] = [ \begin{matrix}S 0 \\ S 1 \\ S 2 \\ S 3\end{matrix} ]$$

where the parameters in the matrix format is matched with the parameters in the equations.
d. In one example determinant general formula may be used to solve the above linear equations.
e. In one example Gaussian elimination approach may be used to solve the above linear equations.
f. In one example any other method, including matrix decomposition may be used to solve the above linear equations.
g. In one example vx1 may equal k*vx0 and vy1 may equal k*vy0, and k may be any real or integer number such as −0.3, 0, 0.1, 2, 3, . . .
   i. In one example any nonlinear method may be used to derive and solve the nonlinear equation.
h. In one example any weighted sum described in the previous sections may be used for the summation.
i. In one example asymmetric BDOF may be applied for both BDOF MV refinement as well as BDOF sample adjustment.
j. In one example asymmetric BDOF may be applied only for the BDOF MV refinement.
k. In one example asymmetric BDOF may be applied only for the BDOF sample adjustment.
l. In one example, whether to and/or how to apply asymmetric BDOF may depend on POC or at least one POC distance.
   i. In one example, whether to and/or how to apply asymmetric BDOF may depend on |POC_ref0−POC_cur| and/or |POC_ref1−POC_cur|, wherein POC_ref0 and POC_ref1 represent the POC of two reference pictures and POC_cur is the POC of the current picture.
m. In one example, whether to and/or how to apply asymmetric BDOF may depend on BCW weights.
n. In one example, whether to and/or how to apply asymmetric BDOF may depend on at least one template of the current block.
   i. Furthermore, whether to and/or how to apply asymmetric BDOF may depend on at least one reference template of the template of the current block.
      On Condition of Applying BDOF and its Combination with Other Tools
16. It is proposed BDOF and/or asymmetric BDOF (MV refinement or sample adjustment or both) may be used in combination or excluded with other tools.
   a. In one example BDOF may be applied for the blocks coded with non-equal BCW weight.
      i. In one example BDOF may be applied with BCW weights from a predefined set, such as {3}, or {3, 5} or {−1, 3}.
   b. In one example BDOF may be applied for the blocks with both reference pictures on the same side of the current frame.
   c. In one example BDOF may be applied for the blocks with reference pictures on the opposite side of the current frame.
      i. In one example they may have the same distance to the current frame.
      ii. In another example they may have different distance from the current frame.
   d. In one example the BDOF may be applied in combination with LIC.
      i. Alternatively, it may be off if block uses LIC.
   e. In one example the BDOF may be applied in combination with OBMC.
      i. Alternatively, it may be off if block uses OBMC.
   f. In one example the BDOF may be applied in combination with CCIP.
      i. Alternatively, it may be off if block uses CIIP.
   g. In one example the BDOF may be applied in combination with SMVD.
      i. Alternatively, it may be off if block uses SMVD.
   h. In one example, BDOF DMVR or BDOF sample may be controlled separately. For example, the BDOF DMVR is applied, but BDOF sample is not applied.
      i. The controlling can be at sub-PU level, or at CU level, or at CTU level.
         On Merging Subblocks with Similar MV Before Applying BDOF DMVR or BDOF Sample
17. It is proposed that multiple subblocks may share the same MV after/before a MV refinement process such as BDOF or DMVR.
   a. In one example, it is proposed to check for similar MVs for neighboring subblocks, and combining them before applying BDOF DMVR or BDOF sample process.
   b. In one example, multiple subblocks sharing the same MV may perform motion compensation as a whole.
   c. In one example N1 neighbor subblocks in one row with similar MVs may be merged.
      i. N1 may be any integer number such as 2, 3, 4, 10, . . .
   d. In one example N2 neighbor subblocks in one column with similar MVs may be merged.
      i. N2 may be any integer number such as 2, 3, 4, 10, . . .
   e. In one example all the neighbor subblocks in one row till rth (first, second, . . . ) round of the DMVR sub-PU boundaries, with similar MVs may be merged. These sub-PU boundaries may happen every K pixel, where K may be any integer number such as 8, 16, 19, 32, . . .
   f. In one example all the neighbor subblocks in one column till rth (first, second, . . . ) round of the DMVR sub-PU boundaries, with similar MVs may be merged. These sub-PU boundaries may happen every K pixel, where K may be any integer number such as 8, 16, 19, 32, . . .
   g. In one example decision to merge row based or column based, may depend on the block size width (W) and/or height (H).
      i. In one example if W>=H, row-based merging approach may be used. Otherwise, column-based merging approach may be used.
      ii. Alternatively, if W<H, row-based merging approach may be used. Otherwise, column-based merging approach may be used.
   h. In one example for each subblocks inside of a bigger M×N subblock, the MV checking and merging process may be applied. M and N may be any integer such as 4, 5, 10, 16, 32, . . .
      i. In one example all 4×4 (or 8×8) subblocks inside of a 16×16 or 8×8 or 16×8 or 32×32 may be merged.
      ii. In one example these M and N may be variable or may be fixed.
   i. In one example all the subblocks inside of a PU or CU may be merged.
   j. In one example, in all the above scenarios, subblocks with almost similar MVs (and not necessarily identical) may be merged too. Almost similar criteria may be defined as if the first order, or second order Euclidian distance of the MVs are smaller than a threshold. The merged MV, may be the average, mode, . . . of all the MVs. Or it could be center or top left or bottom right, or other position's MV.
   k. Alternatively, furthermore, when two subblocks with similar motion, the motion information of one or both subblocks may be modified before being used such that the two subblocks will use the same motion for the preceding operations.
   l. In one example, when two motion use the same reference pictures and MVs are similar (e.g., MV differences is smaller than a threshold), they are treated as similar motions.
   m. The above examples may be applied for each prediction direction.
      i. Alternatively, they may be applied for all prediction directions together.

### On Parallelization, Code Optimization, and Applying Shifts for BDOF

18. It is proposed to apply parallelization for calculating BDOF parameters.
   a. In one example all the related functions' SIMD implementation may be used.
   b. In one example during calculating the sum of the parameters for BDOF sample (or DMVR), K sums of samples' sum at one iteration may be derived. K may be any integer such as 2, 3, 4, 5, 8, . . .
   c. In one example the weighted sums, may be implemented as proper left shifts.
      i. In one example multiplication with weight w_i may be replaced with left shift of

$$log 2 ( 1 + w\_i ) .$$

19. It is proposed to have several code optimizations for BDOF.
   a. In one example BDOF DMVR parameters would not be calculated all the time. Its calculation may be delayed and be conditioned if it is actually needed.
      i. In one example it will only be calculated if no BDOF sample is applied.
   b. In one example BDOF sample parameters would not be calculated all the time. Its calculation may be delayed and be conditioned if it is actually needed.
      i. In one example it will only be calculated if BDOF DMVR stage, resulted in no MV update.
      ii. In one example it will only be calculated if no BDOF DMVR is applied.
   c. In one example for the blocks with BDOF DMVR off, a different subblock size may be used to check BDOF sample applying conditions.
      i. In one example this new subblock size may be bigger or smaller than the BDOF DMVR subblock size. It may be M×N, where M and N may be any integer numbers. Here are some examples for M×N sizes: 2×2, 4×4, 4×8, 8×4, 8×8, . . .
20. It is proposed to add shifts (right or left) at different stage of BDOF parameter derivation in order to remove noise, or avoid overflow, or reduce the bandwidth of the data, or increase accuracy of the derived parameters.
   a. A shift operation may be a right shift or a left shift.
   b. An offset may be added before and/or after the shifting operation.
   c. The shifted results may be clipped to a range.
   d. In one example the data may be shifted by Shift1 before/after calculating gradients. Shift1 maybe any right shift or left shift with any integer value such as 0, 1, 3, 4, 6, . . .
   e. In one example the data may be shifted by Shift2 before/after calculating difference of luminance. Shift2 maybe any right shift or left shift with any integer value such as 0, 1, 3, 4, 6, . . .
   f. In one example the data may be shifted by Shift3 before/after multiplying the gradients or luminance differences. Shift3 maybe any right shift or left shift with any integer value such as 0, 1,3,4, 6 . . .
   g. In one example the data may be shifted by Shift4 before/after calculating the summation of the parameters. Shift4 maybe any right shift or left shift with any integer value such as 0, 1, 3, 4, 6, . . .
   h. In one example the data may be shifted by Shift5 before/after calculating the determinants (multiplications of final parameters). Shift5 maybe any right shift or left shift with any integer value such as 0, 1, 3, 4, 6, . . .
   i. In one example the data may be shifted by Shift6 before/after calculating the determinants' division to get final scaled MV adjustment. Shift6 maybe any right shift or left shift with any integer value such as 0, 1, 3, 4, 6, . . .
   j. In one example the data may be shifted by Shift7 before/after calculating the sample adjustment. Shift7 maybe any right shift or left shift with any integer value such as 0, 1, 3, 4, 6, . . .
   k. In one example, the shift parameter may be dependent to the bit-depth.

### On Iteration for Applying BDOF DMVR

21. It is proposed BDOF DMVR or BDOF sample refinement may be applied in an iterative way.
   a. In one example there may be N iterations for applying BDOF DMVR or BDOF sample refinement, where N maybe any non-negative integer such as 0, 1, 2, 3, 5, 8, . . .
   b. In one example, the refined sample(s) and/or MV(s) in one iterative round of BDOF DMVR or BDOF sample refinement may be applied and used to derive the refinement of the next iterative round of BDOF DMVR or BDOF sample refinement.
   c. In one example number of the iteration may depend on PU/CU/subPU block size, qp, neighboring blocks, temporal layers, and/or combination of all of them. In general, it may depend on the conditions explained in item 14 above.
   d. In one example whether to apply another round of iteration or not, may depend on the previous iteration results. In one embodiment, if the refinement is smaller than a predefined threshold, the iteration will stop. In another embodiment, if the ration between the refinement at current iteration and that at the previous iteration is smaller than a predefined threshold, the iteration will stop.
   e. In one example each iteration may be independent of each other, and the decision for applying another round or not may not be dependent the previous round results.
   f. In one example number of the iterations may depend on the sequence resolution.
   g. In one example number of the iterations may depend on the block size.
   h. In one example number of the iterations may depend on the qp.
   i. In one example number of the iterations may depend to any of the items explained in #14 above.
   j. In one example, the iterative BDOF DMVR or BDOF sample refinement process may be terminated after N rounds of BDOF DMVR or BDOF sample refinement have been performed.
   k. In one example, the iterative BDOF DMVR or BDOF sample refinement process may be terminated when a condition is satisfied.
      i. In one example, the condition is that, a cost is lower than (or no bigger than) a threshold.
      ii. The cost may be defined as the SAD (or SATD or SSD or MR-SAD) between 2 predictions from two lists.
   l. In one example the threshold for applying BDOF DMVR for each subblock in each iteration may be fixed or may be different (for each iteration).
      i. This threshold may be compared to a cost defined between 2 predictions from each list. This cost may be SAD cost between their pixels.
   m. The number of iterations may be signaled at sequence level SPS, or picture level, or slice header.
   n. The number of iterations may depend on the temporal level of the current picture.
22. It is proposed the subblock size for each iteration may be the same or may be different.
   a. In one example all the iteration has the same subblock size.
      i. This same size may be fixed for all the conditions.
      ii. This same size may be adaptive size, as explained in item 14 above.
   b. In one example the iteration j, may have subblock size of W_j*H_j, where j may be any non-negative integer number, and W_j and H_j may be any positive integer such as 2, 4, 8, 11, 16.
      c. In one example each iteration's subblock size may depend to the previous iteration's derived MV.
      d. In one example the subblock size may depend on the sequence resolution and/or combination with any other factors.
23. It is proposed that each iteration may have the same or different scaling for the derived MV adjustment. This scale is multiplied into the derived MV.
   a. In one example all the iteration may have the same scaling factor, s, where s is any real number such as 0.25, 0.4, 0.5, 1, 1.63, 2, 4, . . . . This s is multiplied into the derived BDOF MV.
      i. This same scaling factor may be fixed for all the conditions.
      ii. This same scaling factor may be adaptive depending on the stuff explained in item 14 above.
   b. In one example each iteration may have its own scaling factor, e.g., iteration j would have scaling factor of s_j, where s_j may be any real number such as 0.25, 0.4, 0.5, 1, 1.63, 2, 4, . . .
   c. In one example each iteration's scale factor may depend to the previous and/or current iterations' derived MV.
      i. In one example it may depend on the angle between the derived MVs.
      ii. In one example it may depend on the size of the MVs.
      iii. In one example it may depend on qp value.
      iv. In one example it may depend on a combination of the factors, such as MV size, MV angle, subblock size, qp, block size, . . .
   d. In one example depending on the number of the iteration, and/or derived MV adjustments, and/or other conditions described in item 14, there may be a scaling factor for BDOF sample, i.e., ss. ss may be any real number such as 0.2, 0.25, 0.5, 1.1, . . .
   e. In one example the scaling may depend on the sequence resolution and/or combination with any other factors.

### On DMVR, BDOF DMVR, BDOF Sample for Non-Equal POC Distance Cases.

24. It is proposed that non-equal POC distance may use DMVR, and/or BDOF DMVR, and/or BDOF sample,
   a. In one example non-equal POC distance cases may only use DMVR (without BDOF part).
   b. In one example non-equal POC distance cases may only use BDOF DMVR (without BDOF sample, and other part of DMVR).
   c. In one example non-equal POC distance cases may only use BDOF sample.
   d. In one example non-equal POC distance cases may only use DMVR (with BDOF DMVR part).
   e. In one example non-equal POC distance cases may only use BDOF DMVR as well as BDOF sample (without other part of DMVR).
   f. In one example non-equal POC distance cases may use all DMVR (including BDOF DMVR), and BDOF sample.
   g. In one example BDOF DMVR and/or BDOF sample may use the same formula as described in above sections 1-6.
   h. In another example BDOF DMVR and/or BDOF sample may use an updated formula:

$$\sum Gx \cdot Gx * vx + \sum Gx \cdot Gy * vy = \sum dI \cdot Gx \cdot \to s 1 * vx + s 2 * vy = s 3$$

$$\sum Gx \cdot Gy * vx + \sum Gy \cdot Gy * vy = \sum dI \cdot Gy \to s 2 * vx + s 5 * vy = s 6$$

where, Gx and Gy represents summation of horizontal and vertical gradients for 2 reference pictures, weighted by t0 and t1, respectively. t0 and t1 represent the POC distance of the current frame to ref frame 0 and 1 respectively. And final adjustment for list 0 will be (t0*vx, t0*vy) and for list 1 will be (−t1*vx, −t1*vy).
25. It is proposed that whether to and/or how to perform MV scaling (may also be mentioned as “scaling”) in DMVR may depend on POC distances of at least two reference pictures.
   a. In one example, there may be different scaling for non-equal POC distance cases, where the POC distances of the two reference pictures are different.
   b. In one example in the first round of the DMVR (PU, CU level), there may be no scaling involved, and both list0 and list1 use exact same final MV adjustment with mirror property.
   c. In one example for the first round of the DMVR (PU, CU level), there may be some scaling involved, and list0 and list1 use different final MV adjustment. This scaling however, may or may not be applied during the bilateral matching cost calculation.
   d. In one example list0, may use the derived MV adjustment, and list1 may use the scaled version of list0 MV adjustment. This scale may be proportional to the POC distance of list1 to the current frame, and list0 to the current frame.
   e. In one example list1, may use the derived MV adjustment, and list0 may use the scaled version of list1 MV adjustment. This scale may be proportional to the POC distance of list0 to the current frame, and list1 to the current frame.
   f. In one example the list with shorter POC distance, may use the derived MV adjustment, and the other list may use the scaled up version of the first MV adjustment. This scale may be proportional to the POC distance differences.
   g. In one example the list with longer POC distance, may use the derived MV adjustment, and the other list may use the scaled down version of the first MV adjustment. This scale may be proportional to the POC distance differences.
   h. In one example the scaling value in all the above segments, may be clipped to a predefined minimum and maximum. This scaling may be exactly the POC distance ratio, or a clipped version of it.
   i. In one example in the second round of the DMVR (subPU level), there may be no scaling involved, and both list0 and list1 use exact same final MV adjustment with mirror property.
   j. In one example for the second round of the DMVR (subPU level), there may be some scaling involved, and list0 and list1 use different final MV adjustment. This scaling however, may or may not be applied during the bilateral matching cost calculation.
   k. In one example for the second round of the DMVR, list0, may use the derived MV adjustment, and list1 may use the scaled version of list0 MV adjustment. This scale may be proportional to the POC distance of list1 to the current frame, and list0 to the current frame.
   l. In one example for the second round of the DMVR, list1, may use the derived MV adjustment, and list0 may use the scaled version of list1 MV adjustment. This scale may be proportional to the POC distance of list0 to the current frame, and list1 to the current frame.
   m. In one example for the second round of the DMVR, the list with shorter POC distance, may use the derived MV adjustment, and the other list may use the scaled up version of the first MV adjustment. This scale may be proportional to the POC distance differences.
   n. In one example for the second round of the DMVR, the list with longer POC distance, may use the derived MV adjustment, and the other list may use the scaled down version of the first MV adjustment. This scale may be proportional to the POC distance differences.
   o. In one example for the second round of the DMVR, the scaling value in all the above segments, may be clipped to a predefined minimum and maximum. This scaling may be exactly the POC distance ration, or a clipped version of it.
   p. In one example for the BDOF DMVR part there may be no scaling involved, and both list0 and list1 use exact same MV adjustment with mirror property.
   q. In one example for the BDOF DMVR part, there may be some scaling involved, and list0 and list1 use different MV adjustment.
   r. In one example for the BDOF sample part there may be no scaling involved, and both list0 and list1 use exact same MV adjustment with mirror property.
   s. In one example for the BDOF sample part, there may be some scaling involved, and list0 and list1 use different final MV adjustment. This scaling, however, may or may not be applied during the BDOF formula calculation.
   t. In one example all different the scenarios of scaling, which was explained above for DMVR part, may be applied for BDOF DMVR and/or BDOF sample part too.
26. It is proposed that how and/or how many times to perform motion compensation in DMVR may depend on POC distances of at least two reference pictures.
   a. In one example, there may be at least one time of new motion compensation calculation for non-equal POC distance cases.
   b. In one example for the bilateral matching cost calculation between the pred0 and pred1, the pred0 and pred1 may be derived with the same MV adjustment (and mirror property) for both predictions regardless of the POC distance differences.
   c. In one example for the bilateral matching cost calculation between the pred0 and pred1, the pred0 and pred1 may be derived with the different (scaled) MV adjustment.
   d. In one example this scaled MV adjustment, may be rounded to the closest available prediction (either integer pixel or half pixel level), and that point's prediction may be used.
   e. In one example the prediction for this scaled MV adjustment may be derived using bilinear interpolation between closest available predictions (either integer pixel or half pixel level).
   f. In one example the actual exact perdition for the scaled MV adjustment may be derived.
27. It is proposed non-equal POC distance candidates may be added to the one-sided DMVR candidate list.
   a. In one example up to N candidates with non-equal POC distances may be added to the one-sided DMVR candidate list. N may be any positive integer number such as 1, 2, 5, . . .
   b. Alternatively, no candidates with non-equal POC distances may be added to the one-sided DMVR candidate list.

### On Applying Regularization in BDOF DMVR or BDOF Sample Formula.

28. It is proposed there may be a regularization added to the BDOF DMVR/Sample formula.

$$\sum Gx \cdot Gx * vx + \sum Gx \cdot Gy * vy = \sum dI \cdot Gx \cdot \to s 1 * vx + s 2 * vy = s 3$$

$$\sum Gx \cdot Gy * vx + \sum Gy \cdot Gy * vy = \sum dI \cdot Gy \to s 2 * vx + s 5 * vy = s 6$$

a. In one example regularizer r1, r2, r3, r4, r5, r6 may be added to the BDOF formula and change it to:

$$( s 1 + r 1 ) * vx + ( s 2 + r 2 ) * vy = s 3 + r 3$$

$$( s 2 + r 4 ) * vx + ( s 5 + r 5 ) * vy = s 6 + r 6$$

where r1, r2, r3, r4, r5, r6 may be any integer or real number such as −11, 0, 4, 7, 1<<10, 1<<14, . . . They may be equal or be different than each other.
b. In one example r1=r5, and r2, r3, r4, r6 are zero. r1 may be any integer number.
c. In one example only r3 and r6 are non-zero numbers.
d. In one example r1, r2, r3, r4, r5, r6 are fixed numbers.
e. In another example r1, r2, r3, r4, r5, r6, are variable numbers, and may depend to qp, block size, iteration stage, or any other conditions discussed earlier in this patent.

### General Aspects

29. In one example, the division operation disclosed in the document may be replaced by non-division operations, which may share the same or similar logic to the division-replacement logic in CCLM or CCCM.
30. Whether to and/or how to apply the methods described above may be dependent on coded information.
   a. In one example, the coded information may include block sizes and/or temporal layers, and/or slice/picture types, colour component, et al.
31. Whether to and/or how to apply the methods described above may be indicated in the bitstream.
   a. The indication of enabling/disabling or which method to be applied may be signalled at sequence level/group of pictures level/picture level/slice level/tile group level, such as in sequence header/picture header/SPS/VPS/DPS/DCI/PPS/APS/slice header/tile group header.
   b. The indication of enabling/disabling or which method to be applied may be signaled at PB/TB/CB/PU/TU/CU/VPDU/CTU/CTU row/slice/tile/sub-picture/other kinds of region contain more than one sample or pixel.

More details of the embodiments of the present disclosure will be described below which are related to a bi-directional optical flow (BDOF) process and a decoder side motion vector refinement (DMVR) process. The embodiments of the present disclosure should be considered as examples to explain the general concepts and should not be interpreted in a narrow way. Furthermore, these embodiments can be applied individually or combined in any manner.

As used herein, the term “block” may represent a color component, a sub-picture, a picture, a slice, a tile, a coding tree unit (CTU), a CTU row, groups of CTU, a coding unit (CU), a prediction unit (PU), a transform unit (TU), a coding tree block (CTB), a coding block (CB), a prediction block (PB), a transform block (TB), a sub-block of a video block, a sub-region within a video block, a video processing unit comprising multiple samples/pixels, and/or the like. A block may be rectangular or non-rectangular.

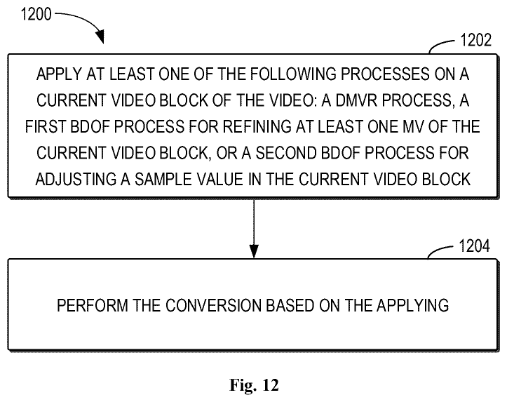

FIG. 12 illustrates a flowchart of a method 1200 for video processing in accordance with some embodiments of the present disclosure. The method 1200 may be implemented during a conversion between a current video block of a video and a bitstream of the video. As shown in FIG. 12, the method 1200 starts at 1202 where at least one of a DMVR process, a first BDOF process for refining at least one motion vector (MV) of the current video block, or a second BDOF process for adjusting a sample value in the current video block is applied on the current video block.

The current video block is bi-predicted based on a first MV and a second MV for the current video block. In addition, a first picture order count (POC) distance between a current picture comprising the current video block and a first reference picture referred to by the first MV is different from a second POC distance between the current picture and a second reference picture referred to by the second MV. This may also be referred to as a non-equal POC distance case or a non-equal POC distance candidate. As used herein, the term “POC distance” may refer to an absolute difference between POCs of two pictures.

For example, the first BDOF process may also be referred to as a BDOF process for MV refinement. In a BDOF process for MV refinement, for example, at least one offset may be determined for refining the MV of the current video block or a subblock of the current video block. In addition, the second BDOF process may also be referred to as a BDOF process for sample adjustment, which is also referred to as sampled-based BDOF. In a BDOF process for sample adjustment, at least one offset may be determined for adjusting one or more predicted samples in the current video block or a subblock of the current video block.

At 1204, the conversion is performed based on a result of applying the plurality of rounds of BDOF process. In some embodiments, the conversion may include encoding the current video block into the bitstream. Alternatively or additionally, the conversion may include decoding the current video block from the bitstream. It should be understood that the above illustrations are described merely for purpose of description. The scope of the present disclosure is not limited in this respect.

In view of the above, the DMVR process, the BDOF for MV refinement, and/or the BDOF for sample adjustment are allowed to be used for non-equal POC distance case. Compare with the conventional solution where these processes are only allowed to be used for equal POC distance case, the proposed solution can advantageously extend the application range of these processes. Thereby, the coding quality can be improved.

In some embodiments, the DMVR process is applied on the current video block, and the first BDOF process and the second BDOF process are not applied on the current video block. In some alternative embodiments, the first BDOF process is applied on the current video block, and the DMVR process and the second BDOF process are not applied on the current video block. In some further embodiments, the second BDOF process is applied on the current video block, and the DMVR process and the first BDOF process are not applied on the current video block. In some still further embodiments, the DMVR process and the first BDOF process are applied on the current video block, and the second BDOF process is not applied on the current video block. In some alternative embodiments, the DMVR process and the second BDOF process are applied on the current video block, and the first BDOF process is not applied on the current video block. In some still further embodiments, the DMVR process, the first BDOF process and the second BDOF process are applied on the current video block.

In some embodiments, a first offset and a second offset for refining an MV is determined for the first BDOF process or the second BDOF process based on the following:

$$s 1 * vx + s 2 * vy = s 3 ,$$

$$s 2 * vx + s 5 * vy = s 6 ,$$

$$s 1 = \sum ( Gx \cdot Gx ) ,$$

$$s 2 = \sum ( Gx \cdot Gy ) ,$$

$$s 3 = \sum ( dI \cdot Gx ) ,$$

$$s 5 = \sum ( Gy \cdot Gx ) ,$$

$$s 6 = \sum ( dI \cdot Gy ) ,$$

wherein Gx represents a summation of values for horizontal gradient determined for each of the first reference picture and the second reference picture, Gy represents a summation of values for vertical gradient determined for each of the first reference picture and the second reference picture, dI represents difference of sample values between the first reference picture and the second reference picture, and Σ( ) represents a weighted sum or a summation inside a target region for the first BDOF process or the second BDOF process, vx represents the first offset, and vy represents the second offset.

In some alternative embodiments, a first offset and a second offset for refining an MV is determined for the first BDOF process or the second BDOF process based on the following:

$$s 1 * vx + s 2 * vy = s 3 ,$$

$$s 2 * vx + s 5 * vy = s 6 ,$$

$$s 1 = \sum ( {Gx}^{′} \cdot {Gx}^{′} ) ,$$

$$s 2 = \sum ( {Gx}^{′} \cdot {Gy}^{′} ) ,$$

$$s 3 = \sum ( dI \cdot {Gx}^{′} ) ,$$

$$s 5 = \sum ( {Gy}^{′} \cdot {Gx}^{′} ) ,$$

$$s 6 = \sum ( dI \cdot {Gy}^{′} ) ,$$

wherein Gx′ represents a weighted sum of values for horizontal gradient determined for each of the first reference picture and the second reference picture, Gy′ represents a weighted sum of values for vertical gradient determined for each of the first reference picture and the second reference picture, values for horizontal gradient and vertical gradient determined for the first reference picture are weighted with a first weight, and values for horizontal gradient and vertical gradient determined for the second reference picture are weighted with a second weight; dI represents difference of sample values between the first reference picture and the second reference picture; Σ( ) represents a weighted sum or a summation inside a target region for the first BDOF process or the second BDOF process; vx represents the first offset; and vy represents the second offset.

In some embodiments, an adjustment (e.g., an MV offset (or offset for short)) of the first MV is determined by weighting the first offset and the second offset with the first weight, and an adjustment (e.g., an MV offset (or offset for short)) of the second MV is determined by weighting the first offset and the second offset with the second weight.

In some embodiments, a first MV offset for the first MV and a second MV offset for the second MV are determined by applying a first round of DMVR process. Whether to scale the first MV offset and the second MV offset, and/or how to scale the first MV offset and the second MV offset may be dependent on the first POC distance and the second POC distance. For example, the first MV offset and the second MV offset are scaled differently. By way of example the first round of DMVR process may be performed at a block level, such a PU level, a CU level or the like.

In some embodiments, a magnitude of the first MV offset is the same as the second MV offset, and the first MV offset and the second MV offset are of opposite directions. In other words, the second MV is a mirrored version of the first MV.

In some embodiments, the first MV offset and the second MV offset are not scaled. In some alternative embodiments, at least one of the first MV offset or the second MV offset is scaled.

In some embodiments, a bilateral matching cost is determined without scaling the at least one of the first MV offset or the second MV offset. Alternatively, the bilateral matching cost is determined based on a result of scaling the at least one of the first MV offset or the second MV offset.

In some embodiments, the first MV offset is scaled and the second MV offset is not scaled, and the scaling factor for scaling the first MV offset is dependent on the first POC distance and the second POC distance. By way of example rather than limitation, the scaling factor is proportional to a ratio between the first POC distance and the second POC distance.

In some embodiments, the first MV offset is associated with a reference picture list 0, and the second MV offset is associated with a reference picture list 1. Altenatively, the first MV offset is associated with the reference picture list 1, and the second MV offset is associated with the reference picture list 0.

In some embodiments, the first POC distance is smaller than the second POC distance. Altenatively, the first POC distance is larger than the second POC distance.

In some embodiments, at least one of the scaled first MV offset or the scaled second MV offset is clipped to a predetermined range. For example, the predetermined range comprises at least one of an upper limit or a lower limit. Alternatively, at least one of the scaled first MV offset or the scaled second MV offset is used without being clipped.

In some additional or alternative embodiments, a first MV offset for the first MV and a second MV offset for the second MV are determined by applying a second round of DMVR process. Whether to scale the first MV offset and the second MV offset, and/or how to scale the first MV offset and the second MV offset may be dependent on the first POC distance and the second POC distance. For example, the first MV offset and the second MV offset are scaled differently. By way of example, the second round of DMVR process may be performed at a subbloc level, such as a sub-PU level or the like.

In some embodiments, a magnitude of the first MV offset is the same as the second MV offset, and the first MV offset and the second MV offset are of opposite directions. In other words, the second MV is a mirrored version of the first MV.

In some embodiments, the first MV offset and the second MV offset are not scaled. In some alternative embodiments, at least one of the first MV offset or the second MV offset is scaled.

In some embodiments, a bilateral matching cost is determined without scaling the at least one of the first MV offset or the second MV offset. Alternatively, the bilateral matching cost is determined based on a result of scaling the at least one of the first MV offset or the second MV offset.

In some embodiments, the first MV offset is scaled and the second MV offset is not scaled, and the scaling factor for scaling the first MV offset is dependent on the first POC distance and the second POC distance. By way of example rather than limitation, the scaling factor is proportional to a ratio between the first POC distance and the second POC distance.

In some embodiments, the first MV offset is associated with a reference picture list 0, and the second MV offset is associated with a reference picture list 1. Altenatively, the first MV offset is associated with the reference picture list 1, and the second MV offset is associated with the reference picture list 0.

In some embodiments, the first POC distance is smaller than the second POC distance. Altenatively, the first POC distance is larger than the second POC distance.

In some embodiments, at least one of the scaled first MV offset or the scaled second MV offset is clipped to a predetermined range. For example, the predetermined range comprises at least one of an upper limit or a lower limit. Alternatively, at least one of the scaled first MV offset or the scaled second MV offset is used without being clipped.

In some additional or alternative embodiments, a first MV offset for the first MV and a second MV offset for the second MV are determined by applying the first BDOF process. Whether to scale the first MV offset and the second MV offset, and/or how to scale the first MV offset and the second MV offset may be dependent on the first POC distance and the second POC distance. For example, the first MV offset and the second MV offset are scaled differently.

In some embodiments, a magnitude of the first MV offset is the same as the second MV offset, and the first MV offset and the second MV offset are of opposite directions. In other words, the second MV is a mirrored version of the first MV.

In some embodiments, the first MV offset and the second MV offset are not scaled. In some alternative embodiments, at least one of the first MV offset or the second MV offset is scaled.

In some embodiments, a BDOF formula calculation (as descirbed in detail in the above secion 4) is performed without scaling the at least one of the first MV offset or the second MV offset. Alternatively, the BDOF formula calculation is performed based on a result of scaling the at least one of the first MV offset or the second MV offset.

In some embodiments, the first MV offset is scaled and the second MV offset is not scaled, and the scaling factor for scaling the first MV offset is dependent on the first POC distance and the second POC distance. By way of example rather than limitation, the scaling factor is proportional to a ratio between the first POC distance and the second POC distance.

In some embodiments, the first MV offset is associated with a reference picture list 0, and the second MV offset is associated with a reference picture list 1. Altenatively, the first MV offset is associated with the reference picture list 1, and the second MV offset is associated with the reference picture list 0.

In some embodiments, the first POC distance is smaller than the second POC distance. Altenatively, the first POC distance is larger than the second POC distance.

In some embodiments, at least one of the scaled first MV offset or the scaled second MV offset is clipped to a predetermined range. For example, the predetermined range comprises at least one of an upper limit or a lower limit. Alternatively, at least one of the scaled first MV offset or the scaled second MV offset is used without being clipped.

In some additionally or alternative embodiments, a first MV offset for the first MV and a second MV offset for the second MV are determined by applying the second BDOF process. Whether to scale the first MV offset and the second MV offset, and/or how to scale the first MV offset and the second MV offset may be dependent on the first POC distance and the second POC distance. For example, the first MV offset and the second MV offset are scaled differently.

In some embodiments, a magnitude of the first MV offset is the same as the second MV offset, and the first MV offset and the second MV offset are of opposite directions. In other words, the second MV is a mirrored version of the first MV.

In some embodiments, the first MV offset and the second MV offset are not scaled. In some alternative embodiments, at least one of the first MV offset or the second MV offset is scaled.

In some embodiments, a BDOF formula calculation is performed without scaling the at least one of the first MV offset or the second MV offset. Alternatively, the BDOF formula calculation is performed based on a result of scaling the at least one of the first MV offset or the second MV offset.

In some embodiments, the first MV offset is scaled and the second MV offset is not scaled, and the scaling factor for scaling the first MV offset is dependent on the first POC distance and the second POC distance. By way of example rather than limitation, the scaling factor is proportional to a ratio between the first POC distance and the second POC distance.

In some embodiments, the first MV offset is associated with a reference picture list 0, and the second MV offset is associated with a reference picture list 1. Altenatively, the first MV offset is associated with the reference picture list 1, and the second MV offset is associated with the reference picture list 0.

In some embodiments, the first POC distance is smaller than the second POC distance. Altenatively, the first POC distance is larger than the second POC distance.

In some embodiments, at least one of the scaled first MV offset or the scaled second MV offset is clipped to a predetermined range. For example, the predetermined range comprises at least one of an upper limit or a lower limit. Alternatively, at least one of the scaled first MV offset or the scaled second MV offset is used without being clipped.

In some embodiments, at least one of the following is dependent on the first POC distance and the second POC distance: how to perform a motion compensation in the DMVR process, or the number of times of performing a motion compensation in the DMVR process. For example, a motion compensation is performed for at least one time. By way of example, a prediction for reference region is determined for at least one time.

In some embodiments, a third MV offset for the first MV and a fourth MV offset for the second MV are determined by applying the DMVR process, and a prediction of the current video block corresponding to the third MV offset and a prediction of the current video block corresponding to the fourth MV offset are determined regardless of the first POC distance and the second POC distance, so as to determine a bilateral matching cost between the predictions.

In some embodiments, a magnitude of the third MV offset is the same as the fourth MV offset, and the third MV offset and the fourth MV offset are of opposite directions. For example, the third MV offset is a mirrored version of the fourth MV offset.

In some embodiments, a third MV offset for the first MV and a fourth MV offset for the second MV are determined by applying the DMVR process. In this case, in one example embodiment, the third MV offset is scaled, and a prediction of the current video block corresponding to the scaled third MV offset and a prediction of the current video block corresponding to the fourth MV offset are determined, so as to determine a bilateral matching cost between the predictions. In another example embodiment, the fourth MV offset is scaled, and a prediction of the current video block corresponding to the third MV offset and a prediction of the current video block corresponding to the scaled fourth MV offset are determined, so as to determine a bilateral matching cost between the predictions. In a further example embodiment, both the third MV offset and the fourth MV offset are scaled, and a prediction of the current video block corresponding to the scaled third MV offset and a prediction of the current video block corresponding to the scaled fourth MV offset are determined, so as to determine a bilateral matching cost between the predictions.

In some embodiments, at least one of a prediction of the current video block corresponding to the scaled third MV offset or a prediction of the current video block corresponding to the scaled fourth MV offset is determined based on the closest available prediction, for example, at an integer pixel or a half pixel level.

In some embodiments, at least one of a prediction of the current video block corresponding to the scaled third MV offset or a prediction of the current video block corresponding to the scaled fourth MV offset is determined based on a bilinear interpolation between the closest available predictions.

In the above cases, the prediction correpsonding to the scaled MV offset is obtained based on an approximation scheme. Thus, no more additional motion compensation is needed.

In some embodiments, at least one of a prediction of the current video block corresponding to the scaled third MV offset or a prediction of the current video block corresponding to the scaled fourth MV offset is determined by performing motion compensation. In thie case, the acurate prediciton is obtained by performing additional motion compensation.

In some embodiments, at least one motion candidate with non-equal POC distances is added to a one-sided DMVR list. In the one-sided DMVR, only one MV in one direction will be refined, rather than refining two MVs. For example, up to N motion candidates with non-equal POC distances are allowed to be added to the one-sided DMVR list, and N is a positive integer number.

In some embodiments, a motion candidate with non-equal POC distances is not allowed to be added to a one-sided DMVR list.

In view of the above, the solutions in accordance with some embodiments of the present disclosure can advantageously improve coding efficiency and coding quality.

According to further embodiments of the present disclosure, a non-transitory computer-readable recording medium is provided. The non-transitory computer-readable recording medium stores a bitstream of a video which is generated by a method performed by an apparatus for video processing. The method comprises: applying at least one of the following processes on a current video block of the video: a decoder side motion vector refinement (DMVR) process, a first bi-directional optical flow (BDOF) process for refining at least one motion vector (MV) of the current video block, or a second BDOF process for adjusting a sample value in the current video block; and generating the bitstream based on the applying, wherein the current video block is bi-predicted based on a first MV and a second MV for the current video block, and a first picture order count (POC) distance between a current picture comprising the current video block and a first reference picture referred to by the first MV is different from a second POC distance between the current picture and a second reference picture referred to by the second MV.

According to still further embodiments of the present disclosure, a method for storing bitstream of a video is provided. The method comprises: applying at least one of the following processes on a current video block of the video: a decoder side motion vector refinement (DMVR) process, a first bi-directional optical flow (BDOF) process for refining at least one motion vector (MV) of the current video block, or a second BDOF process for adjusting a sample value in the current video block; generating the bitstream based on the applying; and storing the bitstream in a non-transitory computer-readable recording medium, wherein the current video block is bi-predicted based on a first MV and a second MV for the current video block, and a first picture order count (POC) distance between a current picture comprising the current video block and a first reference picture referred to by the first MV is different from a second POC distance between the current picture and a second reference picture referred to by the second MV.

Implementations of the present disclosure can be described in view of the following clauses, the features of which can be combined in any reasonable manner.
Clause 1. A method for video processing, comprising: applying, for a conversion between a current video block of a video and a bitstream of the video, at least one of the following processes on the current video block: a decoder side motion vector refinement (DMVR) process, a first bi-directional optical flow (BDOF) process for refining at least one motion vector (MV) of the current video block, or a second BDOF process for adjusting a sample value in the current video block; and performing the conversion based on the applying, wherein the current video block is bi-predicted based on a first MV and a second MV for the current video block, and a first picture order count (POC) distance between a current picture comprising the current video block and a first reference picture referred to by the first MV is different from a second POC distance between the current picture and a second reference picture referred to by the second MV.
Clause 2. The method of clause 1, wherein the DMVR process is applied on the current video block, and the first BDOF process and the second BDOF process are not applied on the current video block.
Clause 3. The method of clause 1, wherein the first BDOF process is applied on the current video block, and the DMVR process and the second BDOF process are not applied on the current video block.
Clause 4. The method of clause 1, wherein the second BDOF process is applied on the current video block, and the DMVR process and the first BDOF process are not applied on the current video block.
Clause 5. The method of clause 1, wherein the DMVR process and the first BDOF process are applied on the current video block, and the second BDOF process is not applied on the current video block.
Clause 6. The method of clause 1, wherein the DMVR process and the second BDOF process are applied on the current video block, and the first BDOF process is not applied on the current video block.
Clause 7. The method of clause 1, wherein the DMVR process, the first BDOF process and the second BDOF process are applied on the current video block.
Clause 8. The method of any of clauses 1-7, wherein a first offset and a second offset for refining an MV is determined for the first BDOF process or the second BDOF process based on the following:

$$s 1 * vx + s 2 * vy = s 3 ,$$

$$s 2 * vx + s 5 * vy = s 6 ,$$

$$s 1 = \sum ( Gx \cdot Gx ) ,$$

$$s 2 = \sum ( Gx \cdot Gy ) ,$$

$$s 3 = \sum ( dI \cdot Gx ) ,$$

$$s 5 = \sum ( Gy \cdot Gx ) ,$$

$$s 6 = \sum ( dI \cdot Gy ) ,$$

wherein Gx represents a summation of values for horizontal gradient determined for each of the first reference picture and the second reference picture, Gy represents a summation of values for vertical gradient determined for each of the first reference picture and the second reference picture, dI represents difference of sample values between the first reference picture and the second reference picture, and Σ( ) represents a weighted sum or a summation inside a target region for the first BDOF process or the second BDOF process, vx represents the first offset, and vy represents the second offset.
Clause 9. The method of any of clauses 1-7, wherein a first offset and a second offset for refining an MV is determined for the first BDOF process or the second BDOF process based on the following:

$$s 1 * vx + s 2 * vy = s 3 ,$$

$$s 2 * vx + s 5 * vy = s 6 ,$$

$$s 1 = \sum ( {Gx}^{′} \cdot {Gx}^{′} ) ,$$

$$s 2 = \sum ( {Gx}^{′} \cdot {Gy}^{′} ) ,$$

$$s 3 = \sum ( dI \cdot {Gx}^{′} ) ,$$

$$s 5 = \sum ( {Gy}^{′} \cdot {Gx}^{′} ) ,$$

$$s 6 = \sum ( dI \cdot {Gy}^{′} ) ,$$

wherein Gx′ represents a weighted sum of values for horizontal gradient determined for each of the first reference picture and the second reference picture, Gy′ represents a weighted sum of values for vertical gradient determined for each of the first reference picture and the second reference picture, values for horizontal gradient and vertical gradient determined for the first reference picture are weighted with a first weight, and values for horizontal gradient and vertical gradient determined for the second reference picture are weighted with a second weight; dI represents difference of sample values between the first reference picture and the second reference picture; Σ( ) represents a weighted sum or a summation inside a target region for the first BDOF process or the second BDOF process; vx represents the first offset; and vy represents the second offset.
Clause 10. The method of clause 9, wherein an adjustment of the first MV is determined by weighting the first offset and the second offset with the first weight, and an adjustment of the second MV is determined by weighting the first offset and the second offset with the second weight.
Clause 11. The method of any of clauses 1-10, wherein a first MV offset for the first MV and a second MV offset for the second MV are determined by applying one of a first round of DMVR process, a second round of DMVR process, the first BDOF process or the second BDOF process, and at least one of the following is dependent on the first POC distance and the second POC distance: whether to scale the first MV offset and the second MV offset, or how to scale the first MV offset and the second MV offset.
Clause 12. The method of clause 11, wherein the first MV offset and the second MV offset are scaled differently.
Clause 13. The method of clause 11, wherein the first MV offset and the second MV offset are not scaled.
Clause 14. The method of any of clauses 11-13, wherein a magnitude of the first MV offset is the same as the second MV offset, and the first MV offset and the second MV offset are of opposite directions.
Clause 15. The method of any of clauses 11-12 and 14, wherein at least one of the first MV offset or the second MV offset is scaled.
Clause 16. The method of clause 15, wherein a bilateral matching cost is determined without scaling the at least one of the first MV offset or the second MV offset, or wherein the bilateral matching cost is determined based on a result of scaling the at least one of the first MV offset or the second MV offset, or wherein a BDOF formula calculation is performed without scaling the at least one of the first MV offset or the second MV offset, or wherein the BDOF formula calculation is performed based on a result of scaling the at least one of the first MV offset or the second MV offset.
Clause 17. The method of any of clauses 15-16, wherein the first MV offset is scaled and the second MV offset is not scaled, and the scaling factor for scaling the first MV offset is dependent on the first POC distance and the second POC distance.
Clause 18. The method of clause 17, wherein the scaling factor is proportional to a ratio between the first POC distance and the second POC distance.
Clause 19. The method of any of clauses 17-18, wherein the first MV offset is associated with a reference picture list 0, and the second MV offset is associated with a reference picture list 1, or wherein the first MV offset is associated with the reference picture list 1, and the second MV offset is associated with the reference picture list 0.
Clause 20. The method of any of clauses 17-18, wherein the first POC distance is smaller than the second POC distance, or wherein the first POC distance is larger than the second POC distance.
Clause 21. The method of any of clauses 11-20, wherein at least one of the scaled first MV offset or the scaled second MV offset is clipped to a predetermined range.
Clause 22. The method of clause 21, wherein the predetermined range comprises at least one of an upper limit or a lower limit.
Clause 23. The method of any of clauses 1-22, wherein at least one of the following is dependent on the first POC distance and the second POC distance: how to perform a motion compensation in the DMVR process, or the number of times of performing a motion compensation in the DMVR process.
Clause 24. The method of any of clauses 1-23, wherein a motion compensation is performed for at least one time.
Clause 25. The method of any of clauses 23-24, wherein a third MV offset for the first MV and a fourth MV offset for the second MV are determined by applying the DMVR process, and a prediction of the current video block corresponding to the third MV offset and a prediction of the current video block corresponding to the fourth MV offset are determined regardless of the first POC distance and the second POC distance, so as to determine a bilateral matching cost between the predictions.
Clause 26. The method of clause 25, wherein a magnitude of the third MV offset is the same as the fourth MV offset, and the third MV offset and the fourth MV offset are of opposite directions.
Clause 27. The method of any of clauses 23-24, wherein a third MV offset for the first MV and a fourth MV offset for the second MV are determined by applying the DMVR process, and the third MV offset is scaled, and a prediction of the current video block corresponding to the scaled third MV offset and a prediction of the current video block corresponding to the fourth MV offset are determined, so as to determine a bilateral matching cost between the predictions, or the fourth MV offset is scaled, and a prediction of the current video block corresponding to the third MV offset and a prediction of the current video block corresponding to the scaled fourth MV offset are determined, so as to determine a bilateral matching cost between the predictions, or the third MV offset and the fourth MV offset are scaled, and a prediction of the current video block corresponding to the scaled third MV offset and a prediction of the current video block corresponding to the scaled fourth MV offset are determined, so as to determine a bilateral matching cost between the predictions.
Clause 28. The method of clause 27, wherein at least one of a prediction of the current video block corresponding to the scaled third MV offset or a prediction of the current video block corresponding to the scaled fourth MV offset is determined based on the closest available prediction.
Clause 29. The method of clause 27, wherein at least one of a prediction of the current video block corresponding to the scaled third MV offset or a prediction of the current video block corresponding to the scaled fourth MV offset is determined based on a bilinear interpolation between the closest available predictions.
Clause 30. The method of clause 27, wherein at least one of a prediction of the current video block corresponding to the scaled third MV offset or a prediction of the current video block corresponding to the scaled fourth MV offset is determined by performing motion compensation.
Clause 31. The method of any of clauses 1-30, wherein at least one motion candidate with non-equal POC distances is added to a one-sided DMVR list.
Clause 32. The method of clause 31, wherein up to N motion candidates with non-equal POC distances are allowed to be added to the one-sided DMVR list, and N is a positive integer number.
Clause 33. The method of any of clauses 1-30, wherein a motion candidate with non-equal POC distances is not allowed to be added to a one-sided DMVR list.
Clause 34. The method of any of clauses 1-33, wherein the conversion includes encoding the current video block into the bitstream.
Clause 35. The method of any of clauses 1-33, wherein the conversion includes decoding the current video block from the bitstream.
Clause 36. An apparatus for video processing comprising a processor and a non-transitory memory with instructions thereon, wherein the instructions upon execution by the processor, cause the processor to perform a method in accordance with any of clauses 1-35.
Clause 37. A non-transitory computer-readable storage medium storing instructions that cause a processor to perform a method in accordance with any of clauses 1-35.
Clause 38. A non-transitory computer-readable recording medium storing a bitstream of a video which is generated by a method performed by an apparatus for video processing, wherein the method comprises: applying at least one of the following processes on a current video block of the video: a decoder side motion vector refinement (DMVR) process, a first bi-directional optical flow (BDOF) process for refining at least one motion vector (MV) of the current video block, or a second BDOF process for adjusting a sample value in the current video block; and generating the bitstream based on the applying, wherein the current video block is bi-predicted based on a first MV and a second MV for the current video block, and a first picture order count (POC) distance between a current picture comprising the current video block and a first reference picture referred to by the first MV is different from a second POC distance between the current picture and a second reference picture referred to by the second MV.
Clause 39. A method for storing a bitstream of a video, comprising: applying at least one of the following processes on a current video block of the video: a decoder side motion vector refinement (DMVR) process, a first bi-directional optical flow (BDOF) process for refining at least one motion vector (MV) of the current video block, or a second BDOF process for adjusting a sample value in the current video block; generating the bitstream based on the applying; and storing the bitstream in a non-transitory computer-readable recording medium, wherein the current video block is bi-predicted based on a first MV and a second MV for the current video block, and a first picture order count (POC) distance between a current picture comprising the current video block and a first reference picture referred to by the first MV is different from a second POC distance between the current picture and a second reference picture referred to by the second MV.

### Example Device

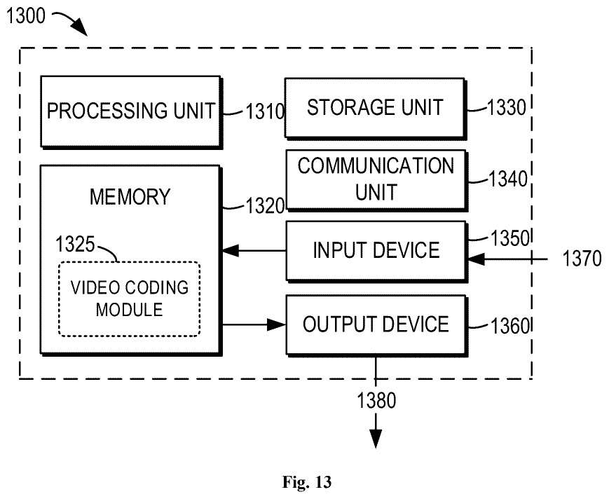

FIG. 13 illustrates a block diagram of a computing device 1300 in which various embodiments of the present disclosure can be implemented. The computing device 1300 may be implemented as or included in the source device 110 (or the video encoder 114 or 200) or the destination device 120 (or the video decoder 124 or 300).

It would be appreciated that the computing device 1300 shown in FIG. 13 is merely for purpose of illustration, without suggesting any limitation to the functions and scopes of the embodiments of the present disclosure in any manner.

As shown in FIG. 13, the computing device 1300 includes a general-purpose computing device 1300. The computing device 1300 may at least comprise one or more processors or processing units 1310, a memory 1320, a storage unit 1330, one or more communication units 1340, one or more input devices 1350, and one or more output devices 1360.

In some embodiments, the computing device 1300 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 1300 can support any type of interface to a user (such as “wearable” circuitry and the like).

The processing unit 1310 may be a physical or virtual processor and can implement various processes based on programs stored in the memory 1320. In a multi-processor system, multiple processing units execute computer executable instructions in parallel so as to improve the parallel processing capability of the computing device 1300. The processing unit 1310 may also be referred to as a central processing unit (CPU), a microprocessor, a controller or a microcontroller.

The computing device 1300 typically includes various computer storage medium. Such medium can be any medium accessible by the computing device 1300, including, but not limited to, volatile and non-volatile medium, or detachable and non-detachable medium. The memory 1320 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 1330 may be any detachable or non-detachable medium and may include a machine-readable medium such as a memory, flash memory drive, magnetic disk or another other media, which can be used for storing information and/or data and can be accessed in the computing device 1300.

The computing device 1300 may further include additional detachable/non-detachable, volatile/non-volatile memory medium. Although not shown in FIG. 13, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 1340 communicates with a further computing device via the communication medium. In addition, the functions of the components in the computing device 1300 can be implemented by a single computing cluster or multiple computing machines that can communicate via communication connections. Therefore, the computing device 1300 can operate in a networked environment using a logical connection with one or more other servers, networked personal computers (PCs) or further general network nodes.

The input device 1350 may be one or more of a variety of input devices, such as a mouse, keyboard, tracking ball, voice-input device, and the like. The output device 1360 may be one or more of a variety of output devices, such as a display, loudspeaker, printer, and the like. By means of the communication unit 1340, the computing device 1300 can further communicate with one or more external devices (not shown) such as the storage devices and display device, with one or more devices enabling the user to interact with the computing device 1300, or any devices (such as a network card, a modem and the like) enabling the computing device 1300 to communicate with one or more other computing devices, if required. Such communication can be performed via input/output (I/O) interfaces (not shown).

In some embodiments, instead of being integrated in a single device, some or all components of the computing device 1300 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 1300 may be used to implement video encoding/decoding in embodiments of the present disclosure. The memory 1320 may include one or more video coding modules 1325 having one or more program instructions. These modules are accessible and executable by the processing unit 1310 to perform the functionalities of the various embodiments described herein.

In the example embodiments of performing video encoding, the input device 1350 may receive video data as an input 1370 to be encoded. The video data may be processed, for example, by the video coding module 1325, to generate an encoded bitstream. The encoded bitstream may be provided via the output device 1360 as an output 1380.

In the example embodiments of performing video decoding, the input device 1350 may receive an encoded bitstream as the input 1370. The encoded bitstream may be processed, for example, by the video coding module 1325, to generate decoded video data. The decoded video data may be provided via the output device 1360 as the output 1380.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for video processing, comprising:
applying, for a conversion between a current video block of a video and a bitstream of the video, at least one of the following processes on the current video block:
a decoder side motion vector refinement (DMVR) process,
a first bi-directional optical flow (BDOF) process for refining at least one motion vector (MV) of the current video block, or
a second BDOF process for adjusting a sample value in the current video block; and
performing the conversion based on the applying,
wherein the current video block is bi-predicted based on a first MV and a second MV for the current video block, and a first picture order count (POC) distance between a current picture comprising the current video block and a first reference picture referred to by the first MV is different from a second POC distance between the current picture and a second reference picture referred to by the second MV.

2. The method of claim 1, wherein the DMVR process is applied on the current video block, and the first BDOF process and the second BDOF process are not applied on the current video block, or
wherein the first BDOF process is applied on the current video block, and the DMVR process and the second BDOF process are not applied on the current video block, or
wherein the second BDOF process is applied on the current video block, and the DMVR process and the first BDOF process are not applied on the current video block, or
wherein the DMVR process and the first BDOF process are applied on the current video block, and the second BDOF process is not applied on the current video block, or
wherein the DMVR process and the second BDOF process are applied on the current video block, and the first BDOF process is not applied on the current video block, or
wherein the DMVR process, the first BDOF process and the second BDOF process are applied on the current video block.

3. The method of claim 1, wherein a first offset and a second offset for refining an MV is determined for the first BDOF process or the second BDOF process based on the following:
$$s 1 * vx + s 2 * vy = s 3 ,$$
$$s 2 * vx + s 5 * vy = s 6 ,$$
$$s 1 = \sum ( Gx \cdot Gx ) ,$$
$$s 2 = \sum ( Gx \cdot Gy ) ,$$
$$s 3 = \sum ( dI \cdot Gx ) ,$$
$$s 5 = \sum ( Gy \cdot Gx ) ,$$
$$s 6 = \sum ( dI \cdot Gy ) ,$$
wherein Gx represents a summation of values for horizontal gradient determined for each of the first reference picture and the second reference picture, Gy represents a summation of values for vertical gradient determined for each of the first reference picture and the second reference picture, dI represents difference of sample values between the first reference picture and the second reference picture, and Σ( ) represents a weighted sum or a summation inside a target region for the first BDOF process or the second BDOF process, vx represents the first offset, and vy represents the second offset.

4. The method of claim 1, wherein a first offset and a second offset for refining an MV is determined for the first BDOF process or the second BDOF process based on the following:
$$s 1 * vx + s 2 * vy = s 3 ,$$
$$s 2 * vx + s 5 * vy = s 6 ,$$
$$s 1 = \sum ( {Gx}^{′} \cdot {Gx}^{′} ) ,$$
$$s 2 = \sum ( {Gx}^{′} \cdot {Gy}^{′} ) ,$$
$$s 3 = \sum ( dI \cdot {Gx}^{′} ) ,$$
$$s 5 = \sum ( {Gy}^{′} \cdot {Gx}^{′} ) ,$$
$$s 6 = \sum ( dI \cdot {Gy}^{′} ) ,$$
wherein Gx′ represents a weighted sum of values for horizontal gradient determined for each of the first reference picture and the second reference picture, Gy′ represents a weighted sum of values for vertical gradient determined for each of the first reference picture and the second reference picture, values for horizontal gradient and vertical gradient determined for the first reference picture are weighted with a first weight, and values for horizontal gradient and vertical gradient determined for the second reference picture are weighted with a second weight; dI represents difference of sample values between the first reference picture and the second reference picture; Σ( ) represents a weighted sum or a summation inside a target region for the first BDOF process or the second BDOF process; vx represents the first offset; and vy represents the second offset.

5. The method of claim 4, wherein an adjustment of the first MV is determined by weighting the first offset and the second offset with the first weight, and an adjustment of the second MV is determined by weighting the first offset and the second offset with the second weight.

6. The method of claim 1, wherein a first MV offset for the first MV and a second MV offset for the second MV are determined by applying one of a first round of DMVR process, a second round of DMVR process, the first BDOF process or the second BDOF process, and at least one of the following is dependent on the first POC distance and the second POC distance:
whether to scale the first MV offset and the second MV offset, or
how to scale the first MV offset and the second MV offset.

7. The method of claim 6, wherein the first MV offset and the second MV offset are scaled differently, or
wherein the first MV offset and the second MV offset are not scaled, or
wherein a magnitude of the first MV offset is the same as the second MV offset, and the first MV offset and the second MV offset are of opposite directions, or
wherein at least one of the scaled first MV offset or the scaled second MV offset is clipped to a predetermined range.

8. The method of claim 6, wherein at least one of the first MV offset or the second MV offset is scaled.

9. The method of claim 8, wherein a bilateral matching cost is determined without scaling the at least one of the first MV offset or the second MV offset, or
wherein the bilateral matching cost is determined based on a result of scaling the at least one of the first MV offset or the second MV offset, or
wherein a BDOF formula calculation is performed without scaling the at least one of the first MV offset or the second MV offset, or
wherein the BDOF formula calculation is performed based on a result of scaling the at least one of the first MV offset or the second MV offset, or
wherein the first MV offset is scaled and the second MV offset is not scaled, and a scaling factor for scaling the first MV offset is dependent on the first POC distance and the second POC distance.

10. The method of claim 9, wherein the scaling factor is proportional to a ratio between the first POC distance and the second POC distance, or
wherein the first MV offset is associated with a reference picture list 0, and the second MV offset is associated with a reference picture list 1, or
wherein the first MV offset is associated with the reference picture list 1, and the second MV offset is associated with the reference picture list 0, or
wherein the first POC distance is smaller than the second POC distance, or
wherein the first POC distance is larger than the second POC distance.

11. The method of claim 1, wherein at least one of the following is dependent on the first POC distance and the second POC distance: how to perform a motion compensation in the DMVR process, or the number of times of performing a motion compensation in the DMVR process, or
wherein a motion compensation is performed for at least one time.

12. The method of claim 11, wherein a third MV offset for the first MV and a fourth MV offset for the second MV are determined by applying the DMVR process, and a prediction of the current video block corresponding to the third MV offset and a prediction of the current video block corresponding to the fourth MV offset are determined regardless of the first POC distance and the second POC distance, so as to determine a bilateral matching cost between the predictions.

13. The method of claim 12, wherein a magnitude of the third MV offset is the same as the fourth MV offset, and the third MV offset and the fourth MV offset are of opposite directions.

14. The method of claim 11, wherein a third MV offset for the first MV and a fourth MV offset for the second MV are determined by applying the DMVR process, and
the third MV offset is scaled, and a prediction of the current video block corresponding to the scaled third MV offset and a prediction of the current video block corresponding to the fourth MV offset are determined, so as to determine a bilateral matching cost between the predictions, or
the fourth MV offset is scaled, and a prediction of the current video block corresponding to the third MV offset and a prediction of the current video block corresponding to the scaled fourth MV offset are determined, so as to determine a bilateral matching cost between the predictions, or
the third MV offset and the fourth MV offset are scaled, and a prediction of the current video block corresponding to the scaled third MV offset and a prediction of the current video block corresponding to the scaled fourth MV offset are determined, so as to determine a bilateral matching cost between the predictions.

15. The method of claim 14, wherein at least one of a prediction of the current video block corresponding to the scaled third MV offset or a prediction of the current video block corresponding to the scaled fourth MV offset is determined based on the closest available prediction, or
wherein at least one of a prediction of the current video block corresponding to the scaled third MV offset or a prediction of the current video block corresponding to the scaled fourth MV offset is determined based on a bilinear interpolation between the closest available predictions, or
wherein at least one of a prediction of the current video block corresponding to the scaled third MV offset or a prediction of the current video block corresponding to the scaled fourth MV offset is determined by performing motion compensation.

16. The method of claim 1, wherein at least one motion candidate with non-equal POC distances is added to a one-sided DMVR list.

17. The method of claim 1, wherein the conversion includes encoding the current video block into the bitstream, or
wherein the conversion includes decoding the current video block from the bitstream.

18. An apparatus for video processing comprising a processor and a non-transitory memory with instructions thereon, wherein the instructions upon execution by the processor, cause the processor to perform acts comprising:
applying, for a conversion between a current video block of a video and a bitstream of the video, at least one of the following processes on the current video block:
a decoder side motion vector refinement (DMVR) process,
a first bi-directional optical flow (BDOF) process for refining at least one motion vector (MV) of the current video block, or
a second BDOF process for adjusting a sample value in the current video block; and
performing the conversion based on the applying,
wherein the current video block is bi-predicted based on a first MV and a second MV for the current video block, and a first picture order count (POC) distance between a current picture comprising the current video block and a first reference picture referred to by the first MV is different from a second POC distance between the current picture and a second reference picture referred to by the second MV.

19. A non-transitory computer-readable storage medium storing instructions that cause a processor to perform acts comprising:
applying, for a conversion between a current video block of a video and a bitstream of the video, at least one of the following processes on the current video block:
a decoder side motion vector refinement (DMVR) process,
a first bi-directional optical flow (BDOF) process for refining at least one motion vector (MV) of the current video block, or
a second BDOF process for adjusting a sample value in the current video block; and
performing the conversion based on the applying,
wherein the current video block is bi-predicted based on a first MV and a second MV for the current video block, and a first picture order count (POC) distance between a current picture comprising the current video block and a first reference picture referred to by the first MV is different from a second POC distance between the current picture and a second reference picture referred to by the second MV.

20. A non-transitory computer-readable recording medium storing a bitstream of a video which is generated by a method performed by an apparatus for video processing, wherein the method comprises:
applying at least one of the following processes on a current video block of the video:
a decoder side motion vector refinement (DMVR) process,
a first bi-directional optical flow (BDOF) process for refining at least one motion vector (MV) of the current video block, or
a second BDOF process for adjusting a sample value in the current video block; and
generating the bitstream based on the applying,
wherein the current video block is bi-predicted based on a first MV and a second MV for the current video block, and a first picture order count (POC) distance between a current picture comprising the current video block and a first reference picture referred to by the first MV is different from a second POC distance between the current picture and a second reference picture referred to by the second MV.
